(19) United States
(12) Patent Application Publication
(10) Pub. No.: US 2009/0029020 A1
(43) Pub. Date: Jan. 29, 2009

(54) CYCLODEXTRIN INCLUSION COMPLEXES AND METHODS OF PREPARING SAME

(75) Inventor: Kenneth J. Strassburger, Cincinnati, OH (US)

Correspondence Address: MICHAEL BEST & FRIEDRICH LLP, 100 E WISCONSIN AVENUE, Suite 3300, MILWAUKEE, WI, 53202, US

(73) Assignee: CARGILL, INCORPORATED, Wayzata, MN (US)

(21) Appl. No.: 11/917,176

(22) PCT Filed: Apr. 5, 2006
(86) PCT No.: PCT/US06/12528

§ 371 Date: Jun. 17, 2008

Related U.S. Application Data
(60) Provisional application No. 60/690,459, filed on Jun. 13, 2005.

(51) Int. Cl. A23L 1/48; C08B 31/00; A23L 2/52

(52) U.S. Cl. 426/302; 536/103; 426/590

(57) ABSTRACT

Cyclodextrin inclusion complexes and methods for preparing and using the cyclodextrin inclusion complexes. A method for preparing a cyclodextrin inclusion complex can include dry blending cyclodextrin, an emulsifier and a thickener to form a dry blend, and mixing a solvent and a guest with the dry blend to form a mixture comprising a cyclodextrin inclusion complex. In some embodiments, the mixture can be dried to form a dry powder or emulsified to form an emulsion. The dry powder or the emulsion can be used in a variety of applications (e.g., beverages, food products, chewing gums, dentifrices, candy, flavorings, fragrances, pharmaceuticals, nutraceuticals, cosmetics, agricultural products, photographic emulsions, waste stream systems, and combinations thereof).

### CROSS-REFERENCE TO RELATED APPLICATIONS

Priority is hereby claimed to U.S. Provisional Patent Application No. 60/690,459, filed Jun. 13, 2005, the entire contents of which are incorporated herein by reference.

### BACKGROUND

The following U.S. patents disclose the use of cyclodextrins to complex various guest molecules, and are hereby fully incorporated herein by reference: U.S. Pat. Nos. 4,296,137, 4,296,138 and 4,348,416 to Borden (flavoring material for use in chewing gum, dentifrices, cosmetics, etc.); 4,265,779 to Gandolfo et al. (suds suppressors in detergent compositions); 3,816,393 and 4,054,736 to Hyashi et al. (prostaglandins for use as a pharmaceutical); 3,846,551 to Mifune et al. (insecticidal and acaricidal compositions); 4,024,223 to Noda et al. (menthol, methyl salicylate, and the like); 4,073,931 to Akito et al. (nitro-glycerine); 4,228,160 to Szjetli et al. (indomethacin); 4,247,535 to Bernstein et al. (complement inhibitors); 4,268,501 to Kawamura et al. (anti-asthmatic actives); 4,365,061 to Szjetli et al. (strong inorganic acid complexes); 4,371,673 to Pitha (retinoids); 4,380,626 to Szjetli et al. (hormonal plant growth regulator), 4,438,106 to Wagu et al. (long chain fatty acids useful to reduce cholesterol); 4,474,822 to Sato et al. (tea essence complexes); 4,529,608 to Szjetli et al. (honey aroma), 4,547,365 to Kuno et al. (hair waving active-complexes); 4,596,795 to Pitha (sex hormones); 4,616,008 Hirai et al. (antibacterial complexes); 4,636,343 to Shibanai (insecticide complexes), 4,663,316 to Ninger et al. (antibiotics); 4,675,395 to Fukazawa et al. (hinokitiol); 4,732,759 and 4,728,510 to Shibanai et al. (bath additives); 4,751,095 to Karl et al. (aspartamane); 4,560,571 (coffee extract); 4,632,832 to Okonogi et al. (instant creaming powder); 5,571,782, 5,660,845 and 5,635,238 to Trinh et al. (perfumes, flavors, and pharmaceuticals); 4,548,811 to Kubo et al. (waving lotion); 6,287,603 to Prasad et al. (perfumes, flavors, and pharmaceuticals); 4,906,488 to Pera (olfactants, flavors, medicaments, and pesticides); and 6,638,557 to Qi et al. (fish oils).

Cyclodextrins are further described in the following publications, which are also incorporated herein by reference: (1) Reineccius, T. A., et al. “Encapsulation of flavors using cyclodextrins: comparison of flavor retention in alpha, beta, and gamma types.” Journal of Food Science. 2002; 67(9): 3271-3279; (2) Shiga, H., et al. “Flavor encapsulation and release characteristics of spray-dried powder by the blended encapsulant of cyclodextrin and gum arabic.” Marcel Dekker, Incl., www.dekker.com. 2001; (3) Szente L., et al. “Molecular Encapsulation of Natural and Synthetic Coffee Flavor with β-cyclodextrin.” Journal of Food Science. 1986; 51(4): 1024-1027; (4) Reineccius, G. A., et al. “Encapsulation of Artificial Flavors by β-cyclodextrin.” Perfumer & Flavorist (ISSN 0272-2666) An Allured Publication. 1986: 11(4): 2-6; and (5) Bhandari, B. R., et al. “Encapsulation of lemon oil by paste method using β-cyclodextrin: encapsulation efficiency and profile of oil volatiles.” J. Agric. Food Chem. 1999; 47: 5194-5197.

### SUMMARY

Some embodiments of the present invention provide a method for preparing a cyclodextrin inclusion complex. The method can include dry blending cyclodextrin and an emulsifier to form a dry blend, and mixing a solvent and a guest with the dry blend to form a cyclodextrin inclusion complex.

In some embodiments of the present invention, a method for preparing a cyclodextrin inclusion complex is provided. The method can include mixing cyclodextrin and an emulsifier to form a first mixture, mixing the first mixture with a solvent to form a second mixture, and mixing a guest with the second mixture to form a third mixture.

Some embodiments of the present invention provide a method for preparing a cyclodextrin inclusion complex. The method can include dry blending cyclodextrin and pectin to form a first mixture, mixing the first mixture with water to form a second mixture, and mixing diacetyl with the second mixture to form a third mixture.

In some embodiments of the present invention, a method for preparing a cyclodextrin inclusion complex is provided. The method can include dry blending cyclodextrin, an emulsifier and a thickener to form a dry blend, and mixing a solvent and a guest with the dry blend to form a mixture comprising a cyclodextrin inclusion complex.

Some embodiments of the present invention provide a method for preparing a cyclodextrin inclusion complex. The method can include mixing cyclodextrin, an emulsifier and a thickener to form a first mixture. The method can further include mixing the first mixture with a solvent form a second mixture. The method can further include mixing a guest with the second mixture to form a third mixture comprising a cyclodextrin inclusion complex.

In some embodiments of the present invention, a method for preparing a cyclodextrin inclusion complex is provided. The method can include dry blending cyclodextrin, an emulsifier and a thickener to form a dry blend. The dry blend can include a weight percentage of emulsifier to cyclodextrin of at least about 0.5 wt % and a weight percentage of thickener to cyclodextrin of at least about 0.07 wt %. The method can further include mixing a solvent and a guest with the dry blend to form a mixture comprising a cyclodextrin inclusion complex.

Other features and aspects of the invention will become apparent by consideration of the detailed description and accompanying drawings.

### BRIEF DESCRIPTION OF THE DRAWINGS

FIG. 1 is a schematic illustration of a cyclodextrin molecule having a cavity, and a guest molecule held within the cavity.

FIG. 2 is a schematic illustration of a nano-structure formed by self-assembled cyclodextrin molecules and guest molecules.

FIG. 3 is a schematic illustration of the formation of a diacetyl-cyclodextrin inclusion complex.

FIG. 4 is a schematic illustration of a nano-structure formed by self-assembled cyclodextrin molecules and diacetyl molecules.

FIG. 5 is a schematic illustration of the formation of a citral-cyclodextrin inclusion complex.

FIG. 6 is a schematic illustration of a nano-structure formed by self-assembled cyclodextrin molecules and citral molecules.

FIG. 7 is a schematic illustration of a three-phase model used to represent a guest-cyclodextrin-solvent system.

FIG. 8 is a calibration curve for acetaldehyde using HPLC to show the relationship between absorbance units and mass (in mg) of acetaldehyde. The calibration curve was obtained according to the procedures outlined in Example 28.

FIG. 9 is a bar graph illustrating the stability of the acetaldehyde-α/β-cyclodextrin inclusion complexes formed according to Examples 26 and 27. The data for the bar graph was obtained according to the procedures outlined in Example 28.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

It also is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between the lowest value and the highest value enumerated are to be considered to be expressly stated in this application.

The present invention is generally directed to cyclodextrin inclusion complexes and methods of forming them. Some cyclodextrin inclusion complexes of the present invention provide for the encapsulation of volatile and reactive guest molecules. In some embodiments, the encapsulation of the guest molecule can provide at least one of the following: (1) prevention of a volatile or reactive guest from escaping a commercial product which may result in a lack of flavor intensity in the commercial product; (2) isolation of the guest molecule from interaction and reaction with other components that would cause off note formation; (3) stabilization of the guest molecule against degradation (e.g., hydrolysis, oxidation, etc.); (4) selective extraction of the guest molecule from other products or compounds; (5) enhancement of the water solubility of the guest molecule; (6) taste or odor improvement or enhancement of a commercial product; (7) thermal protection of the guest in a microwave and conventional baking applications; (8) slow and/or sustained release of flavor or odor (e.g., in embodiments employing diacetyl as the guest molecule in cyclodextrin inclusion complex, it can provide the perception of melting butter); and (9) safe handling of guest molecules.

As used herein and in the appended claims, the term “cyclodextrin” can refer to a cyclic dextrin molecule that is formed by enzyme conversion of starch. Specific enzymes, e.g., various forms of cycloglycosyltransferase (CGTase), can break down helical structures that occur in starch to form specific cyclodextrin molecules having three-dimensional polyglucose rings with, e.g., 6, 7, or 8 glucose molecules. For example, α-CGTase can convert starch to α-cyclodextrin having 6 glucose units, β-CGTase can convert starch to β-cyclodextrin having 7 glucose units, and γ-CGTase can convert starch to γ-cyclodextrin having 8 glucose units. Cyclodextrins include, but are not limited to, at least one of α-cyclodextrin, β-cyclodextrin, γ-cyclodextrin, and combinations thereof. β-cyclodextrin is not known to have any toxic effects, is World-Wide GRAS (i.e., Generally Regarded As Safe) and natural, and is FDA approved. α-cyclodextrin and γ-cyclodextrin are also considered natural products and are U.S and E.U. GRAS.

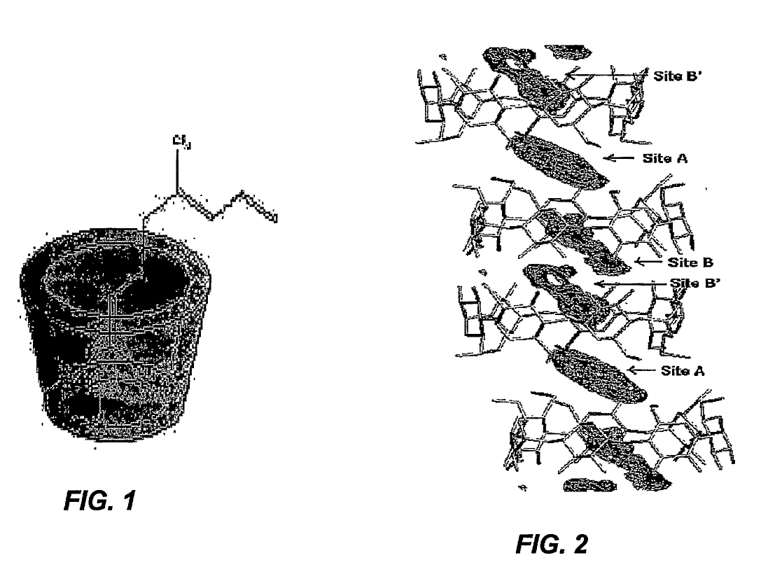

The three-dimensional cyclic structure (i.e., macrocyclic structure) of a cyclodextrin molecule 10 is shown schematically in FIG. 1. The cyclodextrin molecule 10 includes an external portion 12, which includes primary and secondary hydroxyl groups, and which is hydrophilic. The cyclodextrin molecule 10 also includes a three-dimensional cavity 14, which includes carbon atoms, hydrogen atoms and ether linkages, and which is hydrophobic. The hydrophobic cavity 14 of the cyclodextrin molecule can act as a host and hold a variety of molecules, or guests 16, that include a hydrophobic portion to form a cyclodextrin inclusion complex.

As used herein and in the appended claims, the term “guest” can refer to any molecule of which at least a portion can be held or captured within the three dimensional cavity present in the cyclodextrin molecule, including, without limitation, at least one of a flavor, an olfactant, a pharmaceutical, a nutraceutical (e.g., creatine), an antioxidant (e.g., alpha-tocopherol), and combinations thereof.

Examples of flavors can include, without limitation, flavors based on aldehydes, ketones or alcohols. Examples of aldehyde flavors can include, without limitation, at least one of: acetaldehyde (apple); benzaldehyde (cherry, almond); anisic aldehyde (licorice, anise); cinnamic aldehyde (cinnamon); citral (e.g., geranial, alpha citral (lemon, lime) and neral, beta citral (lemon, lime)); decanal (orange, lemon); ethyl vanillin (vanilla, cream); heliotropine, i.e. piperonal (vanilla, cream); vanillin (vanilla, cream); a-amyl cinnamaldehyde (spicy fruity flavors); butyraldehyde (butter, cheese); valeraldehyde (butter, cheese); citronellal (modifies, many types); decenal (citrus fruits); aldehyde C-8 (citrus fruits); aldehyde C-9 (citrus fruits); aldehyde C-12 (citrus fruits); 2-ethyl butyraldehyde (berry fruits); hexenal, i.e. trans-2 (berry fruits); tolyl aldehyde (cherry, almond); veratraldehyde (vanilla); 2-6-dimethyl-5-heptenal, i.e. Melonal™ (melon); 2,6-dimethyloctanal (green fruit); 2-dodecenal (citrus, mandarin); and combinations thereof.

Examples of ketone flavors can include, without limitation, at least one of: d-carvone caraway); 1-carvone (spearmint); diacetyl (butter, cheese, “cream”); benzophenone (fruity and spicy flavors, vanilla); methyl ethyl ketone (berry fruits); maltol (berry fruits) menthone (mints), methyl amyl ketone, ethyl butyl ketone, dipropyl ketone, methyl hexyl ketone, ethyl amyl ketone (berry fruits, stone fruits); pyruvic acid (smokey, nutty flavors); acetanisole (hawthorn heliotrope); dihydrocarvone (spearmint); 2,4-dimethylacetophenone (peppermint); 1,3-diphenyl-2-propanone (almond); acetocumene (orris and basil, spicy); isojasmone (jasmine); d-isomethylionone (orris like, violet); isobutyl acetoacetate (brandy-like); zingerone (ginger); pulegone (peppermint-camphor); d-piperitone (minty); 2-nonanone (rose and tea-like); and combinations thereof.

Examples of alcohol flavors can include, without limitation, at least one of anisic alcohol or p-methoxybenzyl alcohol (fruity, peach); benzyl alcohol (fruity); carvacrol or 2-p-cymenol (pungent warm odor); carveol; cinnamyl alcohol (floral odor); citronellol (rose like); decanol; dihydrocarveol (spicy, peppery); tetrahydrogeraniol or 3,7-dimethyl-1-octanol (rose odor); eugenol (clove); p-mentha-1,8dien-7-Oλ or perillyl alcohol (floral-pine); alpha terpineol; mentha-1,5-dien-8-ol 1; mentha-1,5-dien-8-ol 2; p-cymen-8-ol; and combinations thereof.

Examples of olfactants can include, without limitation, at least one of natural fragrances, synthetic fragrances, synthetic essential oils, natural essential oils, and combinations thereof.

Examples of the synthetic fragrances can include, without limitation, at least one of terpenic hydrocarbons, esters, ethers, alcohols, aldehydes, phenols, ketones, acetals, oximes, and combinations thereof.

Examples of terpenic hydrocarbons can include, without limitation, at least one of lime terpene, lemon terpene, limonen dimer, and combinations thereof.

Examples of esters can include, without limitation, at least one of γ-undecalactone, ethyl methyl phenyl glycidate, allyl caproate, amyl salicylate, amyl benzoate, amyl acetate, benzyl acetate, benzyl benzoate, benzyl salicylate, benzyl propionate, butyl acetate, benzyl butyrate, benzyl phenylacetate, cedryl acetate, citronellyl acetate, citronellyl formate, p-cresyl acetate, 2-t-pentyl-cyclohexyl acetate, cyclohexyl acetate, cis-3-hexenyl acetate, cis-3-hexenyl salicylate, dimethylbenzyl acetate, diethyl phthalate, δ-deca-lactone dibutyl phthalate, ethyl butyrate, ethyl acetate, ethyl benzoate, fenchyl acetate, geranyl acetate, γ-dodecalatone, methyl dihydrojasmonate, isobornyl acetate, β-isopropoxyethyl salicylate, linalyl acetate, methyl benzoate, o-t-butylcylohexyl acetate, methyl salicylate, ethylene brassylate, ethylene dodecanoate, methyl phenyl acetate, phenylethyl isobutyrate, phenylethylphenyl acetate, phenylethyl acetate, methyl phenyl carbinyl acetate, 3,5,5-trimethylhexyl acetate, terpinyl acetate, triethyl citrate, p-t-butylcyclohexyl acetate, vetiver acetate, and combinations thereof.

Examples of ethers can include, without limitation, at least one of p-cresyl methyl ether, diphenyl ether, 1,3,4,6,7,8-hexahydro-4,6,7,8,8-hexamethyl cyclopenta-β-2-benzopyran, phenyl isoamyl ether, and combinations thereof.

Examples of alcohols can include, without limitation, at least one of n-octyl alcohol, n-nonyl alcohol, β-phenylethyldimethyl carbinol, dimethyl benzyl carbinol, carbitol dihydromyrcenol, dimethyl octanol, hexylene glycol linalool, leaf alcohol, nerol, phenoxyethanol, γ-phenyl-propyl alcohol, β-phenylethyl alcohol, methylphenyl carbinol, terpineol, tetraphydroalloocimenol, tetrahydrolinalool, 9-decen-1-ol, and combinations thereof.

Examples of aldehydes can include, without limitation, at least one of n-nonyl aldehyde, undecylene aldehyde, methylnonyl acetaldehyde, anisaldehyde, benzaldehyde, cyclamenaldehyde, 2-hexylhexanal, ahexylcinnamic alehyde, phenyl acetaldehyde, 4-(4-hydroxy-4-methylpentyl)-3-cyclohexene-1-carboxyaldehyde, p-t-butyl-a-methylhydro-cinnamic aldehyde, hydroxycitronellal, α-amylcinnamic aldehyde, 3,5-dimethyl-3-cyclohexene-1-carboxyaldehyde, and combinations thereof.

Examples of phenols can include, without limitation, methyl eugenol.

Examples of ketones can include, without limitation, at least one of 1-carvone, α-damascon, ionone, 4-t-pentylcyclohexanone, 3-amyl-4-acetoxytetrahydropyran, menthone, methylionone, p-t-amycyclohexanone, acetyl cedrene, and combinations thereof.

Examples of the acetals can include, without limitation, phenylacetaldehydedimethyl acetal.

Examples of oximes can include, without limitation, 5-methyl-3-heptanon oxime.

A guest can further include, without limitation, at least one of fatty acids, lactones, terpenes, diacetyl, dimethyl sulfide, proline, furaneol, linalool, acetyl propionyl, natural essences (e.g., orange, tomato, apple, cinnamon, raspberry, etc.), essential oils (e.g., orange, lemon, lime, etc.), sweeteners (e.g., aspartame, neotame, etc.), sabinene, p-cymene, p,a-dimethyl styrene, and combinations thereof.

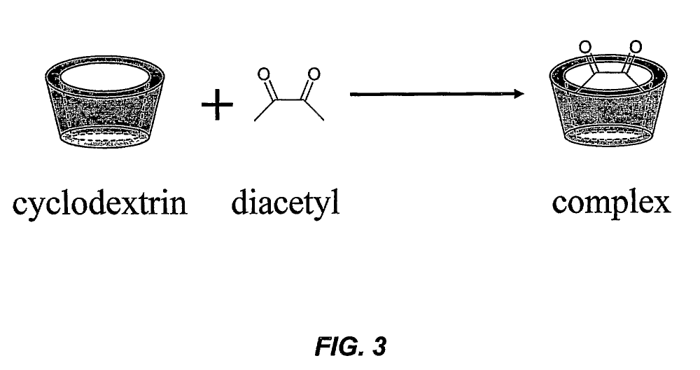

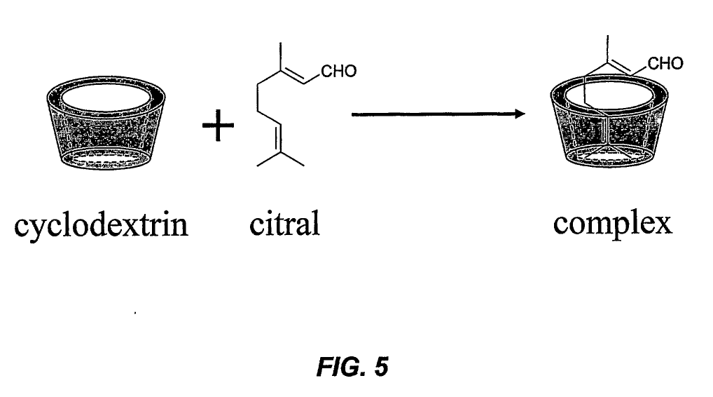

FIG. 3 shows a schematic illustration of the formation of a diacetyl-cyclodextrin inclusion complex, and FIG. 5 shows a schematic illustration of the formation of a citral-cyclodextrin inclusion complex.

As used herein and in the appended claims, the term “log (P)” or “log (P) value” is a property of a material that can be found in standard reference tables, and which refers to the material's octanol/water partition coefficient. Generally, the log (P) value of a material is a representation of its hydrophilicity/hydrophobicity. P is defined as the ratio of the concentration of the material in octanol to the concentration of the material in water. Accordingly, the log (P) of a material of interest will be negative if the concentration of the material in water is higher than the concentration of the material in octanol. The log (P) value will be positive if the concentration is higher in octanol, and the log (P) value will be zero if the concentration of the material of interest is the same in water as in octanol. Accordingly, guests can be characterized by their log (P) value. For reference, Table 1A lists log (P) values for a variety of materials, some of which may be guests of the present invention.

TABLE 1A
Log (P) values for a variety of guests

| Material | CAS# | log P¹ | molecular wt |
|---|---|---|---|
| creatine | 57-00-1 | −3.72 | 131 |
| proline | 147-85-3 | −2.15 | 115 |
| diacetyl | 431-03-8 | −1.34 | 86 |
| methanol | 67-56-1 | −0.74 | 32 |
| ethanol | 64-17-5 | −0.30 | 46 |
| acetone | 67-64-1 | −0.24 | 58 |
| maltol | 118-71-8 | −0.19 | 126 |
| ethyl lactate | 97-64-3 | −0.18 | 118 |
| acetic acid | 64-19-7 | −0.17 | 60 |
| acetaldehyde | 75-07-0 | −0.17 | 44 |
| aspartame | 22839-47-0 | 0.07 | 294 |
| ethyl levulinate | 539-88-8 | 0.29 | 144 |
| ethyl maltol | 4940-11-8 | 0.30 | 140 |
| furaneol | 3658-77-3 | 0.82 | 128 |
| dimethyl sulfide | 75-18-3 | 0.92 | 62 |
| vanillin | 121-33-5 | 1.05 | 152 |
| benzyl alcohol | 100-51-6 | 1.05 | 108 |
| raspberry ketone | 5471-51-2 | 1.48 | 164 |
| benzaldehyde | 100-52-7 | 1.48 | 106 |
| ethyl vanillin | 121-32-4 | 1.50 | 166 |
| phenethyl alcohol | 60-12-8 | 1.57 | 122 |
| cis-3-hexenol | 928-96-1 | 1.61 | 100 |
| trans-2-hexenol | 928-95-0 | 1.61 | 100 |
| whiskey fusel oils | mixture | 1.75 | 74 |
| ethyl isobutyrate | 97-62-1 | 1.77 | 116 |
| ethyl butyrate | 105-54-4 | 1.85 | 116 |
| hexanol | 111-27-3 | 2.03 | 102 |
| ethyl-2-methyl butyrate | 7452-79-1 | 2.26 | 130 |
| ethyl isovalerate | 108-64-5 | 2.26 | 130 |
| isoamyl acetate | 123-92-2 | 2.26 | 130 |
| nutmeg oil | mixture | 2.90 | 164 |
| methyl isoeugenol | 93-16-3 | 2.95 | 164 |
| gamma undecalactone | 104-67-6 | 3.06 | 184 |
| alpha terpineol | 98-55-5 | 3.33 | 154 |
| chlorocyclohexane (CCH) | 542-18-7 | 3.36 | 118 |
| linalool | 78-70-6 | 3.38 | 154 |
| citral | 5392-40-5 | 3.45 | 152 |
| geraniol | 106-24-1 | 3.47 | 154 |
| citronellol | 106-22-9 | 3.56 | 154 |
| p-cymene | 99-87-6 | 4.10 | 134 |
| limonene | 138-86-3 | 4.83 | 136 |

Examples of guests having a relatively large positive log (P) value (e.g., greater than about 2) include, but are not limited to, citral, linalool, alpha terpineol, and combinations thereof. Examples of guests having a relatively small positive log (P) value (e.g. less than about 1 but greater than zero) include, but are not limited to, dimethyl sulfide, furaneol, ethyl maltol, aspartame, and combinations thereof. Examples of guests having a relatively large negative log (P) value (e.g., less than about −2) include, but are not limited to, creatine, proline, and combinations thereof. Examples of guests having a relatively small negative log (P) value (e.g., less than 0 but greater than about −2) include, but are not limited to, diacetyl, acetaldehyde, maltol, aspartame, and combinations thereof.

Log (P) values are significant in many aspects of food and flavor chemistry. A table of log (P) values is provided above. The log (P) values of guests can be important to many aspects of an end product (e.g., foods and flavors). Generally, organic guest molecules having a positive log (P) can be successfully encapsulated in cyclodextrin. In a mixture comprising several guests, competition can exist, and log (P) values can be useful in determining which guests will be more likely to be successfully encapsulated. Maltol and furaneol are examples of two guests that have similar flavor characteristics (i.e., sweet attributes), but which would have different levels of success in cyclodextrin encapsulation because of their differing log (P) values. Log (P) values may be important in food products with a high aqueous content or environment. Compounds with significant and positive log (P) values are, by definition, the least soluble and therefore the first to migrate, separate, and then be exposed to change in the package. The high log (P) value, however, may make them effectively scavenged and protected by addition cyclodextrin in the product.

As mentioned above, the cyclodextrin used with the present invention can include α-cyclodextrin, β-cyclodextrin, γ-cyclodextrin, and combinations thereof. In embodiments in which a more hydrophilic guest (i.e., having a smaller log (P) value) is used, α-cyclodextrin may be used (i.e., alone or in combination with another type of cyclodextrin) to improve the encapsulation of the guest in cyclodextrin. For example, a combination of α-cyclodextrin and β-cyclodextrin can be used in embodiments employing relatively hydrophilic guests to improve the formation of a cyclodextrin inclusion complex. Examples 26 and 27 illustrate one example of using a 50/50 mixture of α-cyclodextrin and β-cyclodextrin to encapsulate acetaldehyde.

As used herein and in the appended claims, the term “cyclodextrin inclusion complex” refers to a complex that is formed by encapsulating at least a portion of one or more guest molecules with one or more cyclodextrin molecules (encapsulation on a molecular level) by capturing and holding a guest molecule within the three dimensional cavity. The guest can be held in position by van der Waal forces within the cavity by at least one of hydrogen bonding and hydrophilic-hydrophobic interactions. The guest can be released from the cavity when the cyclodextrin inclusion complex is dissolved in water. Cyclodextrin inclusion complexes are also referred to herein as “guest-cyclodextrin complexes.” Because the cavity of cyclodextrin is hydrophobic relative to its exterior, guests having positive log (P) values (particularly, relatively large positive log (P) values) will encapsulate easily in cyclodextrin and form stable cyclodextrin inclusion complexes in an aqueous environment, because the guest will thermodynamically prefer the cyclodextrin cavity to the aqueous environment. In some embodiments, when it is desired to complex more than one guest, each guest can be encapsulated separately to maximize the efficiency of encapsulating the guest of interest.

As used herein and in the appended claims, the term “uncomplexed cyclodextrin” generally refers to cyclodextrin that is substantially free of a guest and has not formed a cyclodextrin inclusion complex. Cyclodextrin that is “substantially free of a guest” generally refers to a source of cyclodextrin that includes a large fraction of cyclodextrin that does not include a guest in its cavity.

As used herein and in the appended claims, the term “hydrocolloid” generally refers to a substance that forms a gel with water. A hydrocolloid can include, without limitation, at least one of xanthan gum, pectin, gum arabic (or gum acacia), tragacanth, guar, carrageenan, locust bean, and combinations thereof.

As used herein and in the appended claims, the term “pectin” refers to a hydrocolloidal polysaccharide that can occur in plant tissues (e.g., in ripe fruits and vegetables). Pectin can include, without limitation, at least one of beet pectin, fruit pectin (e.g., from citrus peels), and combinations thereof. The pectin employed can be of varying molecular weight.

Cyclodextrin inclusion complexes of the present invention can be used in a variety of applications or end products, including, without limitation, at least one of foods (e.g., beverages, soft drinks, salad dressings, popcorn, cereal, coffee, cookies, brownies, other desserts, other baked goods, seasonings, etc.), chewing gums, dentifrices, candy, flavorings, fragrances, pharmaceuticals, nutraceuticals, cosmetics, agricultural products or applications (e.g., herbicides, pesticides, etc.), photographic emulsions, and combinations thereof. In some embodiments, cyclodextrin inclusion complexes can be used as intermediate isolation matrices to be further processed, isolated and dried (e.g., as used with waste streams).

Cyclodextrin inclusion complexes can be used to enhance the stability of the guest, convert it to a free flowing powder, or otherwise modify its solubility, delivery or performance. The amount of the guest molecule that can be encapsulated is directly related to the molecular weight of the guest molecule. In some embodiments, one mole of cyclodextrin encapsulates one mole of guest. According to this mole ratio, and by way of example only, in embodiments employing diacetyl (molecular weight of 86 Daltons) as the guest, and β-cyclodextrin (molecular weight 1135 Daltons), the maximum theoretical retention is (86/(86+1135))×100=7.04 wt %.

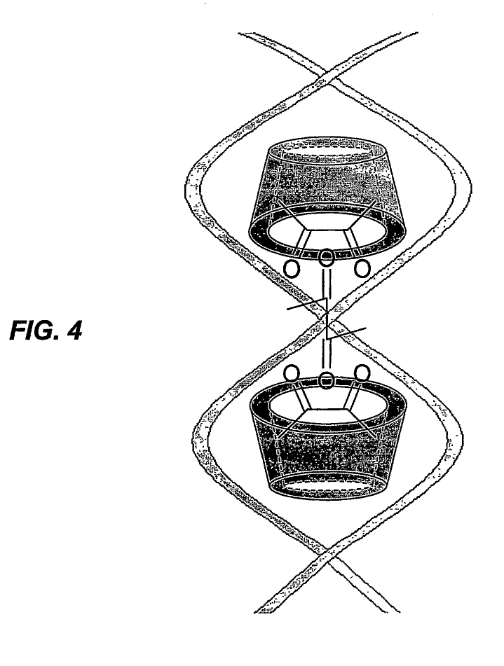

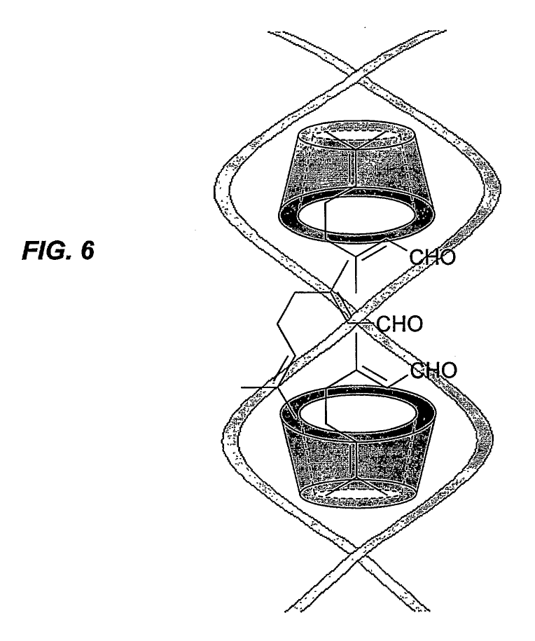

In some embodiments, cyclodextrin can self-assemble in solution to form a nano-structure, such as the nano-structure 20 illustrated in FIG. 2, that can incorporate three moles of a guest molecule to two moles of cyclodextrin molecules. For example, in embodiments employing diacetyl as the guest, a 10.21 wt % retention of diacetyl is possible, and in embodiments employing citral as the guest, a wt % retention of citral of at least 10 wt % is possible (e.g., 10-14 wt % retention). FIG. 4 shows a schematic illustration of a nano-structure than can form between three moles of diacetyl molecules and two moles of cyclodextrin molecules. FIG. 6 shows a schematic illustration of a nano-structure than can form between three moles of citral molecules and two moles of cyclodextrin molecules. Other complex enhancing agents, such as pectin, can aid in the self-assembly process, and can maintain the 3:2 mole ratio of guest:cyclodextrin throughout drying. In some embodiments, because of the self-assembly of cyclodextrin molecules into nano-structures, a 5:3 mole ratio of guest:cyclodextrin is possible.

Cyclodextrin inclusion complexes form in solution. The drying process temporarily locks at least a portion of the guest in the cavity of the cyclodextrin and can produce a dry, free flowing powder comprising the cyclodextrin inclusion complex.

The hydrophobic (water insoluble) nature of the cyclodextrin cavity will preferentially trap like (hydrophobic) guests most easily at the expense of more water-soluble (hydrophilic) guests. This phenomenon can result in an imbalance of components as compared to typical spray drying and a poor overall yield.

In some embodiments of the present invention, the competition between hydrophilic and hydrophobic effects is avoided by selecting key ingredients to encapsulate separately. For example, in the case of butter flavors, fatty acids and lactones form cyclodextrin inclusion complexes more easily than diacetyl. However, these compounds are not the key character impact compounds associated with butter, and they will reduce the overall yield of diacetyl and other water soluble and volatile ingredients. In some embodiments, the key ingredient in butter flavor (i.e., diacetyl) is maximized to produce a high impact, more stable, and more economical product. By way of further example, in the case of lemon flavors, most lemon flavor components will encapsulate equally well in cyclodextrin. However, terpenes (a component of lemon flavor) have little flavor value, and yet make up approximately 90% of a lemon flavor mixture, whereas citral is a key flavor ingredient for lemon flavor. In some embodiments, citral is encapsulated alone. By selecting key ingredients (e.g., diacetyl, citral, etc.) to encapsulate separately, the complexity of the starting material is reduced, allowing optimization of engineering steps and process economics.

In some embodiments, the inclusion process for forming the cyclodextrin inclusion complex is driven to completion by adding a molar excess of the guest. For example, in some embodiments (e.g., when the guest used is diacetyl), the guest can be combined with the cyclodextrin in a 3:1 molar ratio of guest:cyclodextrin. In some embodiments, using a molar excess of guest in forming the complex not only drives the formation of the cyclodextrin inclusion complex, but can also male up for any loss of guest in the process, e.g., in embodiments employing a volatile guest.

In some embodiments, the viscosity of the suspension, emulsion or mixture formed by mixing the cyclodextrin and guest molecules in a solvent is controlled, and compatibility with common spray drying technology is maintained without other adjustments, such as increasing the solids content. An emulsifier (e.g., a thickener, gelling agent, polysaccharide, hydrocolloid) can be added to maintain intimate contact between the cyclodextrin and the guest, and to aid in the inclusion process. Particularly, low molecular weight hydrocolloids can be used. One preferred hydrocolloid is pectin. Emulsifiers can aid in the inclusion process without requiring the use of high heat or co-solvents (e.g., ethanol, acetone, isopropanol, etc.) to increase solubility.

In some embodiments, the water content of the suspension, emulsion or mixture is reduced to essentially force the guest to behave as a hydrophobic compound. This process can increase the retention of even relatively hydrophilic guests, such as acetaldehyde, diacetyl, dimethyl sulfide, etc. Reducing the water content can also maximize the throughput through the spray dryer and reduce the opportunity of volatile guests blowing off in the process, which can reduce overall yield.

In some embodiments of the present invention, a cyclodextrin inclusion complex can be formed by the following process, which may include some or all of the following steps:

(1) Dry blending cyclodextrin and an emulsifier (e.g., pectin);

(2) Combining the dry blend of cyclodextrin and the emulsifier with a solvent such as water in a reactor, and agitating;

(3) Adding the guest and stirring (e.g., for approximately 5 to 8 hours);

(4) Cooling the reactor (e.g., turning on a cooling jacket);

(5) Stirring the mixture (e.g., for approximately 12 to 36 hours);

(6) Emulsifying (e.g., with an in-tank lightning mixer or high shear drop-in mixer); and

(7) Drying the cyclodextrin inclusion complex to form a powder.

These steps need not necessarily be performed in the order listed. In addition, the above process has proved to be very robust in that the process can be performed using variations in temperature, time of mixing, and other process parameters.

In some embodiments, step 1 in the process described above can be accomplished using an in-tank mixer in the reactor to which the hot water will be added in step 2. For example, in some embodiments, the process above is accomplished using a 1000 gallon reactor equipped with a jacket for temperature control and an inline high shear mixer, and the reactor is directly connected to a spray drier. In some embodiments, the cyclodextrin and emulsifier can be dry blended in a separate apparatus (e.g., a ribbon blender, etc.) and then added to the reactor in which the remainder of the above process is completed.

A variety of weight percents of an emulsifier to cyclodextrin can be used, including, without limitation, an emulsifier:cyclodextrin weight percentage of at least about 0.5%, particularly, at least about 1%, and more particularly, at least about 2%. In addition, an emulsifier:cyclodextrin weight percentage of less than about 10% can be used, particularly, less than about 6%, and more particularly, less than about 4%.

Additional materials can be dry blended with the cyclodextrin and emulsifier, including one or more thickeners, and buffers. As used herein and in the appended claims, the term “thickener” can be used to refer to materials that cause an increase in viscosity of the mixture and that inhibit phase separation of the mixture without significantly affecting the formation of a cyclodextrin inclusion complex. Thickeners can include, but are not limited to, a variety of gelling agents, polysaccharides, hydrocolloids, etc., and combinations thereof. Particularly, low molecular weight hydrocolloids can be used. One preferred hydrocolloid is xanthan gum.

As used herein and in the appended claims, the term “buffer” refers to a substance that can be added to a solution to control the pH of the mixture and maintain a substantially neutral mixture. The buffer appropriate for each application will vary, and may depend at least in part on the guest that is used. A variety of buffers known in the art can be used with the present invention. For example, when acetaldehyde is used, the mixture can become acidic, and a buffer such as potassium citrate can be added to the dry blend to control the pH of the mixture and inhibit the mixture from becoming too acidic (i.e., the acetaldehyde can be stabilized and inhibited from being hydrolyzed).

Step 2 in the process described above can be accomplished in a reactor that is jacketed for heating, cooling, or both. In some embodiments, the combining and agitating can be performed at room temperature. In some embodiments, the combining and agitating can be performed at a temperature greater than room temperature. The reactor size can be dependent on the production size. For example, a 100 gallon reactor can be used. The reactor can include a paddle agitator and a condenser unit. In some embodiments, step 1 is completed in the reactor, and in step 2, hot deionized water is added to the dry blend of cyclodextrin and pectin in the same reactor.

Step 3 can be accomplished in a sealed reactor, or the reactor can be temporarily exposed to the environment while the guest is added, and the reactor can be re-sealed after the addition of the guest. Heat can be added when the guest is added and during the stirring of step 3. For example, in some embodiments, the mixture is heated to about 55-60 degrees C.

Step 4 can be accomplished using a coolant system that includes a cooling jacket. For example, the reactor can be cooled with a propylene glycol coolant and a cooling jacket.

The agitating in step 2, the stirring in step 3, and the stirring in step 5 can be accomplished by at least one of shaking, stirring, tumbling, and combinations thereof.

In step 6, the mixture of the cyclodextrin, emulsifier, water and guest can be emulsified using at least one of a high shear mixer (e.g., a ROSS-brand mixer (e.g., at 10,000 RPM for 90 seconds), or a SILVERSTON-brand mixer (e.g., at 10,000 RPM for 5 minutes)), a lightning mixer, or simple mixing followed by transfer to a homogenization pump that is part of a spray dryer, and combinations thereof.

Step 7 in the process described above can be accomplished by at least one of air drying, vacuum drying, spray drying (e.g., with a nozzle spray drier, a spinning disc spray drier, etc.), oven drying, and combinations thereof.

The process outlined above can be used to provide cyclodextrin inclusion complexes with a variety of guests for a variety of applications or end products. For example, some of the embodiments of the present invention provide a cyclodextrin inclusion complex with a guest comprising diacetyl, which can be used for various food products as a butter flavoring (e.g., in microwave popcorn, baked goods, etc.). In addition, some embodiments provide a cyclodextrin inclusion complex with a guest comprising citral, which can be used for acid stable beverages. Furthermore, some embodiments provide a cyclodextrin inclusion complex with a combination of flavor molecules as the guest that can mimic the butter flavoring of diacetyl. For example, the cyclodextrin inclusion complex can alternatively include at least one of dimethyl sulfide (a volatile sulfur compound), proline (an amino acid) and furaneol (a sweetness enhancer) as the guest. This diacetyl-free cyclodextrin inclusion complex can be used to provide a butter flavoring to food products, such as those described above. For cyclodextrin inclusion complexes that can be used in microwavable products, the very close association of guests enhances, for example, maillard and browning reactions, which can generate new and distinct aromas.

In some embodiments of the present invention, step 1 of the process described above can be modified to include:

(1) Dry blending cyclodextrin, an emulsifier (e.g., pectin), and a thickener (e.g., xanthan gum).

Dry blending the thickener with cyclodextrin and the emulsifier can be accomplished by first dry blending two of the three ingredients and then adding the third ingredient, or the three ingredients can be dry blended simultaneously with one another. In such embodiments, the emulsifier is used as described above to enhance the inclusion of the guest molecule in forming the cyclodextrin inclusion complex. The thickener, in such embodiments, is used primarily to increase the viscosity of the mixture prior to the drying step (i.e., step 7 of the process described above) and to substantially prevent phase separation of the cyclodextrin inclusion complex and the rest of the mixture. Because the thickener can be used to increase the viscosity of the mixture and to reduce phase separation of the complex from the rest of the mixture, the thickener can contribute to improving the manufacturability of the cyclodextrin inclusion complex.

In some embodiments, low amounts (e.g., weight percents) of one or more thickeners is added to the cyclodextrin and the emulsifier. The thickener may be substantially inert in the cyclodextrin inclusion complex formation. In other words, the thickener is added to enhance the solubility of the cyclodextrin inclusion complex in the final mixture prior to drying, and to substantially prevent the cyclodextrin inclusion complexes from settling out of the solution/slurry/mixture. However, the thickener does not participate in the inclusion process. In addition, the thickener does not affect the formation of cyclodextrin inclusion complexes. Specifically, the wt % retention of the guest in cyclodextrin is not substantially affected by the presence of the thickener, and the desired effect or function of the final product that the guest-cyclodextrin complex will be used in is not substantially affected.

Because the thickener reduces phase separation of the resulting mixture/slurry of the cyclodextrin inclusion complex in water prior to drying, the thickener enhances the production of an emulsion-compatible cyclodextrin-containing product (e.g., a flavor emulsion). The emulsion-compatible product can be added to another final product (e.g., a beverage, a salad dressing, a dessert, and/or a seasoning). In some embodiments, the emulsion-compatible product can be provided in the form of, or be added to, a syrup or a coating mix, which can be sprayed onto a substrate as a stable coating (e.g., a flavor emulsion sprayed onto cereal, a dessert, a seasoning, nutritional bars, and/or snack foods such as pretzels, chips, etc.). Thus, the thickener facilitates the use of the cyclodextrin inclusion complex in other forms besides a dry powder.

Providing the cyclodextrin inclusion complex in a liquid form can, but need not, have several advantages. First, the liquid form can be more familiar and user friendly for beverage customers who are accustomed to adding flavor compositions to their beverages in the form of a liquid concentrate. Second, the liquid form can be easily sprayed onto dry food products including those listed above to achieve an evenly-distributed and stable coating that includes the flavor composition. Unlike existing spray-on applications, the sprayed-on flavor composition comprising the cyclodextrin inclusion complex would not require the typical volatile solvents or additional coatings or protective layers to maintain the flavor composition on that dry substrate. Third, cyclodextrin can extend the shelf-life of such food products, because cyclodextrin is not hygroscopic, and thus will not lead to staleness, flatness, or reduced freshness of the base food product or beverage. Fourth, drying processes can be costly, and some guest (e.g., free guest or guest present in a cyclodextrin inclusion complex) can be lost during drying, which can make the drying step difficult to optimize and perform economically. For these reasons and others that are not specifically mentioned here, providing the cyclodextrin inclusion complex in a liquid form in some embodiments can be beneficial. The emulsion form of the cyclodextrin inclusion complex can be added to a final product (e.g., a beverage or food product) to impart the appropriate guest profile (e.g., flavor profile) to the final product, while ensuring that the cyclodextrin in the final product is within legal limits (e.g., no greater than 0.2 wt % of the final product).

In some embodiments, the thickener is dry blended with the cyclodextrin, and no emulsifier is used. In some embodiments, the same material is used as the emulsifier and the thickener (e.g., xanthan gum is used as an emulsifier and a thickener), and in some embodiments, the emulsifier is different from the thickener (e.g., pectin is used as an emulsifier, and xanthan gum is used as a thickener). Improved guest-cyclodextrin complex formation and decreased phase separation has been observed when the emulsifier used is a different material than the thickener used. For example, a synergy has been observed when pectin is used as an emulsifier, and xanthan gum is used as a thickener.

In some embodiments, the addition of the thickener eliminates the need for further emulsification of the mixture (i.e., eliminates step 6 above). Eliminating the emulsification step alleviates transferring the mixture to any additional tank for emulsification prior to drying. Eliminating the emulsification step further reduces the number of steps required in the process, increases throughput, and reduces the total cost of manufacturing. In addition, it allows the entire process to be performed in one tank, from which the mixture is dried (e.g., pumped to a spray drier), allowing the entire process to occur in a closed system. By performing the process in a closed system, worker and environmental exposure to guest molecules or other chemicals is reduced.

In some embodiments, at some point in the process between steps 3 and 7 described above (e.g., in some embodiments in which step 7, the drying step, has been eliminated), an additional amount of thickener can be added. In some embodiments, the thickener added at this later time point can be the same thickener that was dry blended with the cyclodextrin and the emulsifier, it can be the same emulsifier that was included in the dry blend, or it can be a new material that has not yet been used. For example, in some embodiments, the suspension of the emulsion can be improved by adding 1-2 wt % of gum acacia.

The thickener can be added in a weight percentage of thickener to the total mixture (i.e., cyclodextrin, emulsifier, thickener, water, guest) of at least about 0.02 wt %, particularly, at least about 0.05 wt %, particularly, at least about 0.06 wt %, and more particularly, about 0.10 wt %. In addition, a thickener:total mixture weight percentage of less than about 0.4 wt % can be used, particularly, less than about 0.2 wt %, and more particularly, less than about 0.13 wt %.

Furthermore, a thickener:cyclodextrin weight percentage of at least about 0.07 wt % can be used, particularly, at least about 0.19 wt %, particularly, at least about 0.22 wt %, and more particularly, about 0.375 wt %. In addition, a thickener:cyclodextrin weight percentage of less than about 1.5 wt % can be used, particularly, less than about 0.75 wt %, and more particularly, less than about 0.5 wt %.

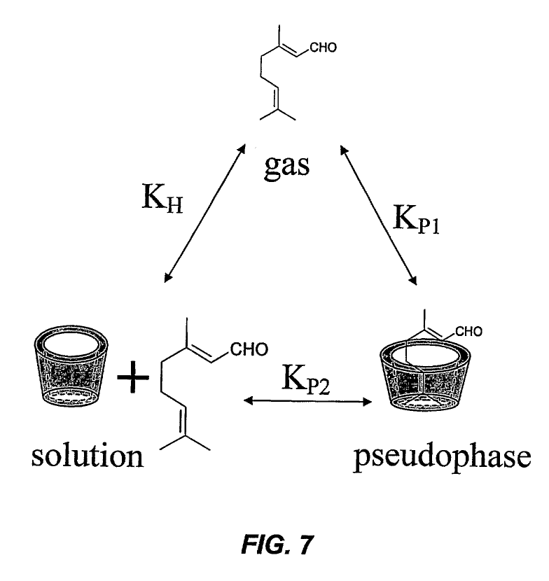

FIG. 7 illustrates a three-phase model that represents a guest-cyclodextrin-solvent system. The guest used in FIG. 7 is citral, and the solvent used is water, but it should be understood that citral and water are shown in FIG. 7 for the purpose of illustration only. One of ordinary skill in the art, however, will understand that the three-phase model shown in FIG. 7 can be used to represent a wide variety of guests and solvents. Additional information regarding a three-phase model similar to the one illustrated in FIG. 7 can be found in Lantz et al., “Use of the three-phase model and headspace analysis for the facile determination of all partition/association constants for highly volatile solute-cyclodextrin-water systems,” Anal Bioanal Chem (2005) 383: 160-166, which is incorporated herein by reference.

This three-phase model can be used to explain the phenomena that occur (1) during formation of the cyclodextrin inclusion complex, (2) in a beverage application of the cyclodextrin inclusion complex, and/or (3) in a flavor emulsion. The flavor emulsion can include, for example, the slurry formed in step 5 or 6 in the process described above prior to or without drying, or a slurry formed by resuspending a dry powder comprising a cyclodextrin inclusion complex in a solvent. Such a flavor emulsion can be added to a beverage application (e.g., as a concentrate), or sprayed onto a substrate, as described above.

As shown in FIG. 7, there are three phases in which the guest can be present, namely, the gaseous phase, the aqueous phase, and the cyclodextrin phase (also sometimes referred to as a “pseudophase”). Three equilibria, and their associated equilibrium constants (i.e., K_{H}, K_{P1} and K_{P2}) are used to describe the presence of the guest in these three phases:

$$\begin{matrix}{S}_{( g )} {\to }^{ {K}_{H }} {S}_{( aq )} ; {K}_{H} = \frac{{C}_{S}^{aq}}{{P}_{S}} ( based on Henry ' s Law \text{:} {K}_{H} = \frac{{C}_{S}}{{P}_{S}} ) & ( 1 ) \\ {S}_{( g )} {\to }^{ {K}_{P 1 }} {S}_{( CD )} ; {K}_{P 1} = \frac{{C}_{S}^{CD}}{{P}_{S}} & ( 2 ) \\ {S}_{( aq )} {\to }^{ {K}_{P 2 }} {S}_{( CD )} ; {K}_{P 2} = \frac{{C}_{S}^{CD}}{{C}_{S}^{aq}} & ( 3 ) \\ {K}_{H} = \frac{{K}_{P 1}}{{K}_{P 2}} & ( 4 )\end{matrix}$$

wherein “S” represents the solute (i.e., the guest) of the system in the corresponding phase of the system which is denoted in the subscript, “g” represents the gaseous phase, “aq” represents the aqueous phase, “CD” represents the cyclodextrin phase, “C_{S}” represents the concentration of the solute in the corresponding phase (i.e., aq or CD, denoted in the superscript), and “P_{S}” represents the partial pressure of the solute in the gaseous phase.

To account for all of the guest in the three-phase system shown in FIG. 7, it follows that the total number of moles of guest (n_{S}^{total}) can be represented by the following equation:

n_{S}^{total}=n_{S}^{g}+n_{S}^{aq}+n_{S}^{CD}. (5)

To account for any loss of the guest in a product (e.g., a beverage or flavor emulsion) at steady state, the total number of moles of guest available for sensation (n_{S}^{taste}; e.g., for taste in a beverage or flavor emulsion) can be represented by the following equation:

n_{S}^{taste}=n_{S}^{g}+n_{S}^{aq}+n_{S}^{CD}−f_{(P)} (6)

wherein f_{(P)} is a partitioning function that represents any migration (or loss) of the guest, for example, through a barrier or container (e.g., a plastic bottle formed of polyethylene or polyethylene terephthalate (PET)) in which the beverage of flavor emulsion is contained.

For guests having a large positive log (P) value, encapsulation of the guest in cyclodextrin will be thermodynamically favored (i.e., K_{P1} and K_{P2} will be greater than 1), and the following relationship will occur:

n_{S}^{CD}>>n_{S}^{aq}>n_{S}^{g}>f_{(P)} (7)

such that the majority of the guest present in the system will be in the form of a cyclodextrin inclusion complex. Not only will the amount of free guest in the aqueous and gaseous phases be minimal, but also the migration of guest through the barrier or container will be minimized. Accordingly, the majority of the guest available for sensation will be present in the cyclodextrin phase, and the total number of moles of guest available for sensation (n_{S}^{taste}) can be approximated as follows:

n_{S}^{taste}≈n_{S}^{CD} (8)

The formation of the cyclodextrin inclusion complex in solution between the guest and the cyclodextrin can be more completely represented by the following equation:

$${S}_{( aq )} + {CD}_{( aq )} {\to }^{ {K}_{P 2 }} S \cdot {CD}_{( aq )} ; {K}_{P 2} = \frac{{[ S \cdot CD ]}_{( aq )}}{{{[ S ]}_{( aq )} [ CD ]}_{( aq )}} \qquad ( 9 )$$

Empirically, the data supporting the present invention has shown that the log (P) value of the guest can be a factor in the formation and stability of the cyclodextrin inclusion complex. That is, empirical data has shown that the equilibrium shown in equation 9 above is driven to the right by the net energy loss accompanied by the encapsulation process in solution, and that the equilibrium can be at least partially predicted by the log (P) value of the guest of interest. It has been found that log (P) values of the guests can be a factor in end products with a high aqueous content or environment. For example, guests with relatively large positive log (P) values are typically the least water-soluble and can migrate and separate from an end product, and can be susceptible to a change in the environment within a package. However, the relatively large log (P) value can make such guests effectively scavenged and protected by the addition of cyclodextrin to the end product. In other words, in some embodiments, the guests that have traditionally been the most difficult to stabilize can be easy to stabilize using the methods of the present invention.

To account for the effect of the log (P) value of the guest, the equilibrium constant (K_{P2}′) that represents the stability of the guest in a system can be represented by the following equation:

$${K}_{P 2}^{′} = log ( P ) \frac{{[ S \cdot CD ]}_{( aq )}}{{{[ S ]}_{( aq )} [ CD ]}_{( aq )}} \qquad ( 10 )$$

wherein log (P) is the log (P) value for the guest (S) of interest in the system. Equation 10 establishes a model that takes into account a guest's log (P) value. Equation 10 shows how a thermodynamically stable system can result from forming a cyclodextrin inclusion complex with a guest having a relatively large positive log (P) value. For example, in some embodiments, a stable system can be formed using a guest having a positive log (P) value. In some embodiments, a stable system can be formed using a guest having a log (P) value of at least about +1. In some embodiments, a stable system can be formed using a guest having a log (P) value of at least about +2. In some embodiments, a stable system can be formed using a guest having a log (P) value of at least about +3.

By taking into account the log (P) of the guest, it is possible to predict the stability of the guest in a system that comprises the cyclodextrin inclusion complex. By exploiting the thermodynamics of the complexation in solution, a protective and stable environment can be formed for the guest. Release characteristics of a guest from the cylodextrin can be governed by K_{H}, the guest's air/water partition coefficient. K_{H} can be large compared to log (P) if the system comprising the cyclodextrin inclusion complex is placed in a non-equilibrium situation, such as the mouth. One of ordinary skill in the art will understand that more than one guest can be present in a system, and that similar equations and relationships can be applied to each guest of the system.

Improving the stability of a guest and protecting the guest from degradation is the subject matter of co-pending U.S. patent application Ser. No. ______, filed on the same day herewith, the entire contents of which are incorporated herein by reference.

While log(P) values can be good empirical indicators and are available from several references, another important criteria is the binding constant for a particular guest (i.e., once a complex forms, how strongly is the guest bound in the cyclodextrin cavity). Unfortunately, the binding constant for a guest is determined experimentally. In the case of limonene and citral, for example, citral can form a much stronger complex, even though the log(P) values are similar. As a result, even in the presence of high limonene concentrations, citral is preferentially protected until consumption, because of its higher binding constant. This is an unexpected benefit and is not directly predicted from the current scientific literature.

Various features and aspects of the invention are set forth in the following examples, which are intended to be illustrative and not limiting. All of the examples were performed at atmospheric pressure, unless stated otherwise. Examples 1-31 are working examples. Example 32 is a prophetic example.

### EXAMPLE 1

### Cyclodextrin Inclusion Complex with β-Cyclodextrin, Diacetyl And Pectin as an Emulsifier, and Process for Forming Same

At atmospheric pressure, in a 100 gallon reactor, 49895.1600 g (110.02 lb) of β-cyclodextrin was dry blended with 997.9 g (2.20 lb) of beet pectin (2 wt % of pectin: β-cyclodextrin; XPQ EMP 5 beet pectin available from Degussa-France) to form a dry blend. The 100 gallon reactor was jacketed for heating and cooling, included a paddle agitator, and included a condenser unit. The reactor was supplied with a propylene glycol coolant at approximately 40° F. (4.5° C.). The propylene glycol coolant system is initially turned off, and the jacket acts somewhat as an insulator for the reactor. 124737.9 g (275.05 lb) of hot deionized water was added to the dry blend of β-cyclodextrin and pectin. The water had a temperature of approximately 118° F. (48° C.). The mixture was stirred for approximately 30 min. using the paddle agitator of the reactor. The reactor was then temporarily opened, and 11226.4110 g (24.75 lb) of diacetyl was added (as used hereinafter, “diacetyl” in the examples refers to diacetyl purchased from Aldrich Chemical, Milwaukee, Wis.). The reactor was resealed, and the resulting mixture was stirred for 8 hours with no added heat. Then, the reactor jacket was connected to the propylene glycol coolant system. The coolant was turned on to approximately 40° F. (4.5° C.), and the mixture was stirred for approximately 36 hours. The mixture was then emulsified using a high shear tank mixer, such as what is typically used in spray dry operations. The mixture was then spray dried on a nozzle dryer having an inlet temperature of approximately 410° F. (210° C.) and an outlet temperature of approximately 221° F. (105° C.). A percent retention of 12.59 wt % of diacetyl in the cyclodextrin inclusion complex was achieved. The moisture content was measured at 4.0%. The cyclodextrin inclusion complex included less than 0.3% surface diacetyl, and the particle size of the cyclodextrin inclusion complex was measured as 99.7% through an 80 mesh screen. Those skilled in the art will understand that heating and cooling can be controlled by other means. For example, diacetyl can be added to a room temperature slurry and can be automatically heated and cooled.

### EXAMPLE 2

### Cyclodextrin Inclusion Complex with α-Cyclodextrin, Diacetyl and Pectin as an Emulsifier, and Process for Forming Same

The β-cyclodextrin of example 1 was replaced with α-cyclodextrin and dry blended with 1 wt % pectin (i.e., 1 wt % of pectin: β-cyclodextrin; XPQ EMP 5 beet pectin available from Degussa-France). The mixture was processed and dried by the method set forth in Example 1. The percent retention of diacetyl in the cyclodextrin inclusion complex was 11.4 wt %.

### EXAMPLE 3

### Cyclodextrin Inclusion Complex with β-Cyclodextrin and Orange Essence, Pectin as an Emulsifier, and Process for Forming Same

Orange essence, an aqueous waste stream from juice production, was added as the aqueous phase to a dry blend of β-cyclodextrin and 2 wt % pectin, formed according to the process set forth in Example 1. No additional water was added, the solids content was approximately 28%. The cyclodextrin inclusion complex was formed by the method set forth in Example 1. The dry inclusion complex contained approximately 3 to 4 wt % acetaldehyde, approximately 5 to 7 wt % ethyl butyrate, approximately 2 to 3 wt % linalool and other citrus enhancing notes. The resulting cyclodextrin inclusion complex can be useful in top-noting beverages.

### EXAMPLE 4

### Cyclodextrin Inclusion Complex with β-Cyclodextrin and Acetyl Propionyl, Pectin as an Emulsifier, and Process for Forming Same

A molar excess of acetyl propionyl was added to a dry blend of β-cyclodextrin and 2 wt % pectin in water, following the method set forth in Example 1. The percent retention of acetyl propionyl in the cyclodextrin inclusion complex was 9.27 wt %. The mixture can be useful in top-noting diacetyl-free butter systems.

### EXAMPLE 5

### Orange Oil Flavor Product and Process for Forming Same

Orange oil (i.e., Orange Bresil; 75 g) was added to an aqueous phase comprising 635 g of water, 403.75 g of maltodextrin, and 21.25 g of beet pectin (available from Degussa-France, product no. XPQ EMP 5). The orange oil was added to the aqueous phase with gentle stirring, followed by strong stirring at 10,000 RPM to form a mixture. The mixture was then passed through a homogenizer at 250 bars to form an emulsion. The emulsion was dried using a NIRO-brand spray drier having an inlet temperature of approximately 180° C. and an outlet temperature of approximately 90° C. to form a dried product. The percent flavor retention was then quantified as the amount of oil (in g) in 100 g of the dried product, divided by the oil content in the starting mixture. The percent retention of orange oil was approximately 91.5%.

### EXAMPLE 6

### Orange Oil Flavor Product and Process for Forming Same

Orange oil (75 g) was added to an aqueous phase comprising 635 g of water, 297.50 g of maltodextrin, and 127.50 g gum arabic (available from Colloïds Naturels International). The orange oil was added to the aqueous phase and dried following the method set forth in Example 5. The percent flavor retention was approximately 91.5%.

### EXAMPLE 7

### Orange Oil Flavor Product and Process for Forming Same

Orange oil (75 g) was added to an aqueous phase comprising 635 g of water, 297.50 g of maltodextrin, 123.25 g gum arabic (available from Colloïds Naturels International), and 4.25 g of depolymerized citrus pectin. The orange oil was added to the aqueous phase and dried following the method set forth in Example 5. The percent flavor retention was approximately 96.9%.

### EXAMPLE 8

### Orange Oil Flavor Product and Process for Forming Same

Orange oil (75 g) was added to an aqueous phase comprising 635 g of water, 297.50 g of maltodextrin, 123.25 g gum arabic (available from Colloïds Naturels International), and 4.25 g of beet pectin (available from Degussa-France, product no. XPQ EMP 5). The orange oil was added to the aqueous phase and dried following the method set forth in Example 5. The percent flavor retention was approximately 99.0%.

### EXAMPLE 9

### Orange Oil Flavor Product and Process for Forming Same

Orange oil (75 g) was added to an aqueous phase comprising 635 g of water, 403.75 g of maltodextrin, and 21.25 g of depolymerized citrus pectin. The orange oil was added to the aqueous phase and dried following the method set forth in Example 5. The percent flavor retention was approximately 90.0%.

### EXAMPLE 10

### Orange Oil Flavor Product and Process for Forming Same

Orange oil (75 g) was added to an aqueous phase comprising 635 g of water, 340.00 g of maltodextrin, and 85.00 g gum arabic (available from Colloïds Naturels International). The orange oil was added to the aqueous phase and dried following the method set forth in Example 5. The percent flavor retention was approximately 91.0%.

### EXAMPLE 11

### Orange Oil Flavor Product and Process for Forming Same

Orange oil (75 g) was added to an aqueous phase comprising 635 g of water and 425.00 g of maltodextrin. The orange oil was added to the aqueous phase and dried following the method set forth in Example 5. The percent flavor retention was approximately 61.0%.

### EXAMPLE 12

### Orange Oil Flavor Product and Process for Forming Same

Orange oil (75 g) was added to an aqueous phase comprising 635 g of water, 420.75 g of maltodextrin, and 4.25 g of pectin. The orange oil was added to the aqueous phase and dried following the method set forth in Example 5. The percent flavor retention was approximately 61.9%.

### EXAMPLE 13

### Orange Oil Flavor Product and Process for Forming Same

Orange oil (75 g) was added to an aqueous phase comprising 635 g of water, 403.75 g of maltodextrin, and 21.50 g of pectin. The orange oil was added to the aqueous phase and dried following the method set forth in Example 5. The percent flavor retention was approximately 71.5%.

### EXAMPLE 14

### Orange Oil Flavor Product and Process for Forming Same

Orange oil (75 g) was added to an aqueous phase comprising 635 g of water, 420.75 g of maltodextrin, and 4.75 g of depolymerized citrus pectin. The orange oil was added to the aqueous phase and dried following the method set forth in Example 5. The percent flavor retention was approximately 72.5%.

### EXAMPLE 15

### Orange Oil Flavor Product and Process for Forming Same

Orange oil (75 g) was added to an aqueous phase comprising 635 g of water, 420.75 g of maltodextrin, and 4.75 g of beet pectin (available from Degussa-France, product no. XPQ EMP 5). The orange oil was added to the aqueous phase and dried following the method set forth in Example 5. The percent flavor retention was approximately 78.0%.

### EXAMPLE 16

### Orange Oil Flavor Product and Process for Forming Same

Orange oil (75 g) was added to an aqueous phase comprising 635 g of water, 414.40 g of maltodextrin, and 10.60 g of depolymerized citrus pectin. The orange oil was added to the aqueous phase and dried following the method set forth in Example 5. The percent flavor retention was approximately 85.0%.

### EXAMPLE 17

### Orange Oil Flavor Product and Process for Forming Same

Orange oil (75 g) was added to an aqueous phase comprising 635 g of water, 414.40 g of maltodextrin, and 10.60 g of beet pectin (available from Degussa-France, product no. XPQ EMP 5). The orange oil was added to the aqueous phase and dried following the method set forth in Example 5. The percent flavor retention was approximately 87.0%.

### EXAMPLE 18

### Ability of Xanthan Gum as Thickener to Prevent Phase Separation in Slurry/Mixture of Cyclodextrin Inclusion Complex and Water

Varying amounts of xanthan gum were added to a slurry of water and the diacetyl-cyclodextrin complex formed according to Example 1. Specifically, 28.57 wt % of the diacetyl-cyclodextrin complex was combined with 71.43 wt % water. This study simulates the effect that varying amounts of xanthan gum will have on solubility of the diacetyl-cyclodextrin complex. Warm water (about 30-35 degrees C.) was combined with the diacetyl-cyclodextrin complex and allowed to sit overnight. As shown in Table 1B, the following weight percents of xanthan gum to the total mixture were studied: 0.00 wt %, 0.03 wt %, 0.06 wt %, 0.10 wt % and 0.13 wt %. Each mixture was stirred at a medium stir bar speed of 3 on magnetic stirrer hot plate (available from Corning) for 1 min., and observations were made every 30 min., up to 310 min. As shown in Table 1B, the level of phase separation at each time interval for each mixture is described in terms of “none,” “very slight,” “slight,” “slight to moderate,” or “moderate.” As further shown in Table 1B, weight percents of xanthan gum to the total mixture of at least about 0.10 wt % provided no phase separation at all time intervals.

TABLE 1B
Xanthan gum added to a diacetyl-cyclodextrin complex in water at varying weight
percents to determine amount of xanthan gum sufficient for preventing phase separation.

| % Xanthan Gum | 30 min. | 60 min. | 90 min. | 120 min. | 150 min. | 180 min. | 210 min. | 240 min. | 310 min. |
|---|---|---|---|---|---|---|---|---|---|
| 0.00% | Slight | Slight to | Moderate | Moderate | Moderate | Moderate | Moderate | Moderate | Moderate |
| | | moderate | | | | | | | |
| 0.03% | Very | slight | Slight to | Slight to | Moderate | Moderate | Moderate | Moderate | Moderate |
| | slight | | moderate | moderate | | | | | |
| 0.06% | None | None | None | Very | Very | Very | Very | Very | Slight |
| | | | | slight | slight | slight | slight | slight | |
| 0.10% | None | None | None | None | None | None | None | None | None |
| 0.13% | None | None | None | None | None | None | None | None | None |

### EXAMPLE 19

### Cyclodextrin inclusion complex with a α-Cyclodextrin, Diacetyl and Xanthan Gum as a Thickener, and Process for Forming Same

At atmospheric pressure, in a 4-L reactor, 2 L of deionized water was added to 600 g of α-cyclodextrin (W6 α-cyclodextrin, available from Wacker, Adrian, Mich.) to form a slurry. The 4-L reactor was set up for heating and cooling via a lab-scale water bath heating and cooling apparatus. 50 g of diacetyl was added to the slurry of α-cyclodextrin and water. The resulting mixture was allowed to stir for 3 days (i.e., over a weekend). On the third day, at 12:30 P.M., 50 mL of 5% xanthan gum/propylene glycol (KELTROL xanthan gum, available from CP Kelco, SAP No. 15695) cut in 200 g propylene glycol) was added (0.125 wt % of the xanthan gum/propylene glycol mixture was added). The mixture was then spray dried on a spinning-disc spray dryer (available from Niro) having an inlet temperature of approximately 210 degrees C. and an outlet temperature of approximately 105 degrees C. A percent retention of about 3.29 wt % of diacetyl in the cyclodextrin inclusion complex was achieved.

### EXAMPLE 20

### Cyclodextrin Inclusion Complex with β-Cyclodextrin, Diacetyl and Xanthan Gum as a Thickener, and Process for Forming Same

The α-cyclodextrin of Example 19 was replaced with β-cyclodextrin (W7 β-cyclodextrin, available from Wacker). A percent retention of about 0.75 wt % of diacetyl in the cyclodextrin inclusion complex was achieved.

### EXAMPLE 21

### Cyclodextrin Inclusion Complex with β-Cyclodextrin, Diacetyl, Pectin as an Emulsifier and Xanthan Gum as a Thickener, and Process for Forming Same

At atmospheric pressure, in a 2-L reactor, 400 g of β-cyclodextrin (W7 β-cyclodextrin, available from Wacker), 8 g of beet pectin (2 wt % of pectin: β-cyclodextrin; XPQ EMP 4 beet pectin available from Degussa-France), and 1.5 g xanthan gum (e.g., KELTROL xanthan gum, available from CP Kelco, SAP No. 15695) were dry blended via a shaker together to form a dry blend. 1 L of deionized water was added to the dry blend to form a slurry or mixture. The 2-L reactor was set up for heating and cooling via a lab-scale water bath heating and cooling apparatus. The mixture was heated to about 55-60 degrees C. and agitated by stirring for about 30 min. 91 g of diacetyl was added to the mixture. The reactor was then sealed, and the resulting mixture was stirred for 2 hours at about 55-60 degrees C. The cooling portion of the heating and cooling lab apparatus was then turned on, and the mixture was stirred for about 36 hours at about 5-10 degrees C. The mixture was then spray dried on a BUCHI B-191 lab spray dryer (available from Buchi, Switzerland) having an inlet temperature of approximately 210 degrees C. and an outlet temperature of approximately 105 degrees C. A percent retention of about 8.70 wt % of diacetyl in the cyclodextrin inclusion complex was achieved.

### EXAMPLE 22

### Cyclodextrin Inclusion Complex with β-Cyclodextrin, Acetaldehyde, Pectin as an Emulsifier and Xanthan Gum as a Thickener, and Process for Forming Same

At atmospheric pressure, in a 5-L reactor, 1200 g of β-cyclodextrin (W7 β-cyclodextrin, available from Wacker) and 24 g of beet pectin (2 wt % of pectin: β-cyclodextrin; XPQ EMP 4 beet pectin available from Degussa-France) were dry blended together. 4.27 g xanthan gum (KELTROL xanthan gum, available from CP Kelco, SAP No. 15695) and 9 g potassium citrate were dry blended into the β-cyclodextrin and pectin to form a dry blend. (Potassium citrate was used as a buffer to control the pH of the mixture because of the use of acetaldehyde.) 2.93 L of deionized water was added to the dry blend to form a slurry or mixture. The 5-L reactor was set up for heating and cooling via a lab-scale water bath heating and cooling apparatus. The mixture was cooled to about 5-10 degrees C. and stirred (no condenser was used) for about 30 min. 115.0 g of acetaldehyde (available from Alfebro, a division of Degussa Corporation) cut in 40% water (equivalent to 46 g acetaldehyde) was added after a temperature of 5-10 degrees C. was achieved. The reactor was sealed, and the resulting mixture was stirred overnight at 5-10 degrees C. The mixture was then spray dried on a BOWEN BE 1316 small production spray dryer (available from BOWEN, Somerville, N.J.) having an inlet temperature of approximately 210 degrees C. and an outlet temperature of approximately 105 degrees C. A percent retention of about 2.20 wt % of acetaldehyde in the cyclodextrin inclusion complex was achieved. A yield of 1177 g (90+%) of dry powder was achieved.

### EXAMPLE 23

### Cyclodextrin Inclusion Complex with β-Cyclodextrin, Diacetyl, Pectin as an Emulsifier and Xanthan Gum as a Thickener, and Process for Forming Same

At atmospheric pressure, in a 5-L reactor, 1200 g of β-cyclodextrin (W7 β-cyclodextrin, available from Wacker), 24 g of beet pectin (2 wt % of pectin: β-cyclodextrin; XPQ EMP 4 beet pectin available from Degussa-France), and 4.5 g xanthan gum (KELTROL xanthan gum, available from CP Kelco, SAP No. 15695) were dry blended together to form a dry blend. 3 L of deionized water was added to the dry blend to form a slurry or mixture. The 5-L reactor was set up for heating and cooling via a lab-scale water bath heating and cooling apparatus. The mixture was heated to about 55-60 degrees C. and agitated by stirring for about 30 min. 273 g of diacetyl was added. The reactor was sealed, and the resulting mixture was stirred for 4 hours at about 55-60 degrees C. The cooling portion of the heating and cooling lab apparatus was then turned on, and the mixture was stirred overnight at about 5-10 degrees C. The mixture was then spray dried on a BOWEN BE 1316 small production spray dryer (available from BOWEN, Somerville, N.J.) having an inlet temperature of approximately 210 degrees C. and an outlet temperature of approximately 105 degrees C. A percent retention of about 7.36 wt % of diacetyl in the cyclodextrin inclusion complex was achieved. A 90+% yield of dry powder was achieved.

### EXAMPLE 24

### Cyclodextrin Inclusion Complex with β-Cyclodextrin, Diacetyl, Pectin as an Emulsifier and Xanthan Gum as a Thickener, and Process for Forming Same

In a 2-L reactor, 400 g of β-cyclodextrin (W7 β-cyclodextrin, available from Wacker), 8 g of beet pectin (2 wt % of pectin: β-cyclodextrin; XPQ EMP 4 beet pectin available from Degussa-France), and 1.5 g xanthan gum (KELTROL xanthan gum, available from CP Kelco SAP No. 15695) were dry blended together to form a dry blend. 1 L of deionized water was added to the dry blend to form a slurry or mixture. The 2-L reactor was set up for heating and cooling via a lab-scale water bath heating and cooling apparatus. The mixture was heated to about 55-60 degrees C. and agitated by stirring for about 30 min. 91 g of diacetyl was added. The reactor was sealed, and the resulting mixture was stirred for 4 hours at about 55-60 degrees C. The cooling portion of the heating and cooling lab apparatus was then turned on, and the mixture was stirred overnight at about 5-10 degrees C. The mixture was then spray dried on a BUCHI B-191 lab spray dryer (available from Buchi, Switzerland) having an inlet temperature of approximately 210 degrees C. and an outlet temperature of approximately 105 degrees C. A percent retention of about 8.70 wt % of diacetyl in the cyclodextrin inclusion complex was achieved.

### EXAMPLE 25

### Emulsion Comprising a Cyclodextrin Inclusion Complex with β-Cyclodextrin and Citral, Pectin as an Emulsifier And Xanthan Gum as a Thickener, and Process for Forming Same

At atmospheric pressure, in a 100 gallon reactor, 49895.1600 g (110.02 lb) of β-cyclodextrin, 997.9 g (2.20 lb) of beet pectin (2 wt % of pectin: β-cyclodextrin; XPQ EMP 5 beet pectin available from Degussa-France) and 181.6 g (0.4 lb) of xanthan gum (0.1 wt % of total; KELTROL xanthan gum, available from CP Kelco SAP No. 15695) were dry blended together to form a dry blend. The 100 gallon reactor was jacketed for heating and cooling, included a paddle agitator, and included a condenser unit. The reactor was supplied with a propylene glycol coolant at approximately 40° F. (4.5° C.). The propylene glycol coolant system is initially turned off, and the jacket acts somewhat as an insulator for the reactor. 124737.9 g (275.05 lb) of hot deionized water was added to the dry blend of β-cyclodextrin and pectin. The water had a temperature of approximately 118° F. (48° C.). The mixture was stirred for approximately 30 min. using the paddle agitator of the reactor. The reactor was then temporarily opened, and 1 kg (2.2 lb) of citral (natural citral, SAP No. 921565, Lot No. 10000223137, available from Citrus & Allied) was added. The reactor was resealed, and the resulting mixture was stirred for 6 hours with no added heat. Then, the reactor jacket was connected to the propylene glycol coolant system. The coolant was turned on to approximately 40° F. (4.5° C.), and the mixture was stirred for approximately 6 hours. The mixture was then emulsified using a high shear tank mixer (HP 5 1PQ mixer, available from Silverston Machines Ltd., Chesham England) to form a stable emulsion. The resulting emulsion was stable for 90 days/months/years without settling or separation, and could be used to deliver 20-30 ppm of citral and 0.2 wt % of β-cyclodextrin to a finished beverage or food product. A percent retention of 2.0 wt % of citral in the cyclodextrin inclusion complex was achieved.

### EXAMPLE 26

### Cyclodextrin Inclusion Complex with Acetaldehyde and a 50/50 Mixture of α/β-Cyclodextrin, Pectin as an Emulsifier and Xanthan Gum as a Thickener, and Process for Forming Same

In a 2-L reactor, 200 g of α-cyclodextrin (W6 α-cyclodextrin, available from Wacker), 200 g of β-cyclodextrin (W7 β-cyclodextrin, available from Wacker), 8 g of beet pectin (2 wt % of pectin: total cyclodextrin; XPQ EMP 4 beet pectin available from Degussa-France), 1.46 g (0.1 wt % of total) xanthan gum (KELTROL xanthan gum, available from CP Kelco SAP No. 15695), and 3 g of potassium citrate were dry blended together to form a dry blend. (Potassium citrate was used as a buffer to control the pH of the mixture because of the use of acetaldehyde.) 800 mL of deionized water was added to the dry blend to form a slurry or mixture. The 2-L reactor was set up for heating and cooling via a lab-scale water bath heating and cooling apparatus. Cooling was turned on to cool the slurry to a temperature of about 5-10 degrees C., and the slurry was stirred. 50 g of acetaldehyde was added (3× molar ratio of acetaldehyde to cyclodextrin). The reactor was sealed, and the resulting mixture was stirred overnight at about 5-10 degrees C. The mixture was then spray dried on a BUCHI B-191 lab spray dryer (available from Buchi, Switzerland) having an inlet temperature of approximately 210 degrees C. and an outlet temperature of approximately 105 degrees C. A percent retention of about 2.35 wt % of acetaldehyde in the cyclodextrin inclusion complex was achieved, which was determined using high performance liquid chromatography (HPLC), as explained below in Example 28. The percent moisture of the resulting powder was 6.57%. Duplicate batches were produced over a 3 day period to assure reproducibility. These are labeled CDAB-158 and CDAB 159.

### EXAMPLE 27

### Cyclodextrin Inclusion Complex with Acetaldehyde and a 50/50 Mixture of α/β-Cyclodextrin, Pectin as an Emulsifier and Xanthan Gum as a Thickener, and Process for Forming Same

In a 2-L reactor, 200 g of α-cyclodextrin (W6 α-cyclodextrin, available from Wacker), 200 g of β-cyclodextrin (W7 β-cyclodextrin, available from Wacker), 8 g of beet pectin (2 wt % of pectin: total cyclodextrin; XPQ EMP 4 beet pectin available from Degussa-France), 1.46 g xanthan gum (KELTROL xanthan gum, available from CP Kelco SAP No. 15695), and 3 g of potassium citrate were dry blended together to form a dry blend. (Potassium citrate was used as a buffer to control the pH of the mixture because of the use of acetaldehyde.) 800 mL of deionized water was added to the dry blend to form a slurry or mixture. The 2-L reactor was set up for heating and cooling via a lab-scale water bath heating and cooling apparatus. Cooling was turned on to cool the slurry to a temperature of about 5-10 degrees C., and the slurry was stirred. 25 g (1.5× molar ratio) of acetaldehyde was added. The reactor was sealed, and the resulting mixture was stirred overnight at about 5-10 degrees C. The mixture was then spray dried on a BUCHI B-191 lab spray dryer (available from Buchi, Switzerland) having an inlet temperature of approximately 210 degrees C. and an outlet temperature of approximately 105 degrees C. A percent retention of about 2.45 wt % of acetaldehyde in the cyclodextrin inclusion complex was achieved, which was determined using high performance liquid chromatography (HPLC), as explained below in Example 28. Again, duplicate batches were prepared over a 2-4 day period to assure reproducibility. These are labeled CDAB-175 and CDAB-176.

### EXAMPLE 28

### Stability Study of Acetaldehyde-α/β-Cyclodextrin Complexes from Examples 26 and 27

Following the formation of the acetaldehyde-α/β-cyclodextrin inclusion complexes described in Example 26 (referred to as “CDAB-158”) and Example 27 (referred to as “CDAB-159”), the wt % retention of acetaldehyde was measured using HPLC at various timepoints and temperatures. HPLC for all measurements at all timepoints was performed using an 1050 HPLC System with an autosampler and variable wavelength detector, available from Agilent Technologies, Inc., Palo Alto, Calif. The variable wavelength detector was set at UV:290 nm. The column used with the HLPC system was a HPX-87A Ion Exclusion Column for Organic Acids, available from BioRad Laboratories, Hercules, Calif. The column uses 0.005 M (or 0.01 N) sulfuric acid as the mobile phase. The column and mobile phase was chosen because the mobile phase can completely hydrolyze the cyclodextrin and release the guest molecule for analysis. The column was thermostated at 45 degrees C.

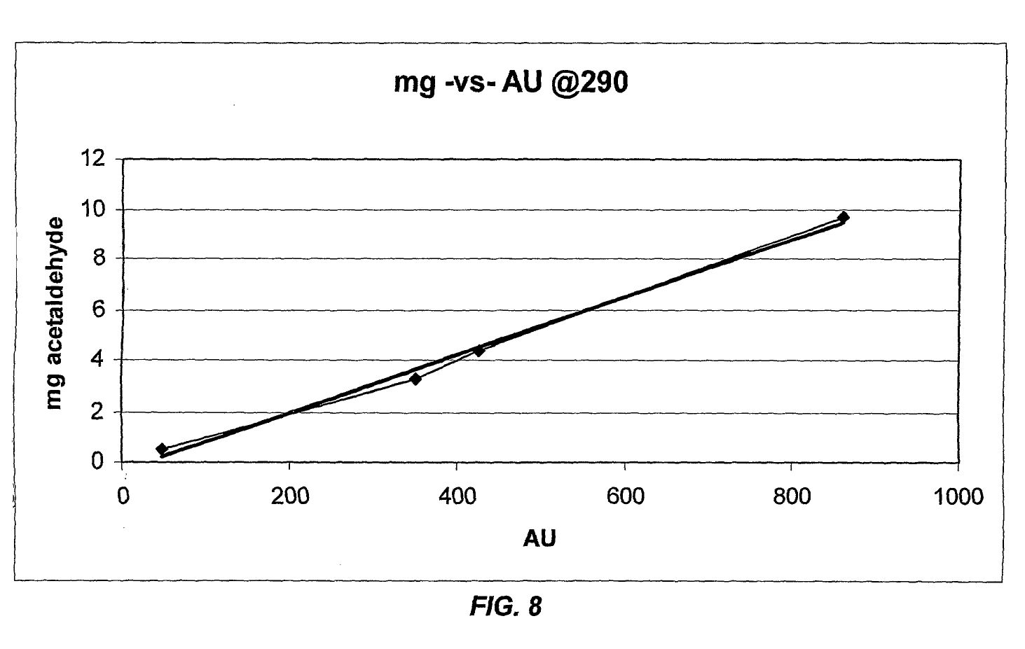

First, an HPLC calibration curve was created for acetaldehyde to form a correlation between absorbance units (AU) in the chromatogram with amount/mass (in mg) of acetaldehyde. The data points used to create the calibration curve for acetaldehyde, which is shown in FIG. 8, are shown below in Table 2:

TABLE 2
Data points used to create the acetaldehyde
HPLC calibration curve shown in FIG. 8.

| Mass of acetaldehyde (in mg) | Absorbance Units (AU) |
|---|---|
| 0.52 | 47.915 |
| 3.26 | 348.612 |
| 4.38 | 424.079 |
| 9.66 | 861.729 |

As shown in FIG. 8, the relationship between the mass (in mg) of acetaldehyde and the absorbance units is substantially linear over the illustrated ranges of mass and absorbance units. Accordingly, if the area count (area under the curve) of the chromatogram for acetaldehyde from a sample fell within the range of the absorbance units in the calibration curve, a simple proportion was used to estimate the mass (in mg) of acetaldehyde that was present in that sample.

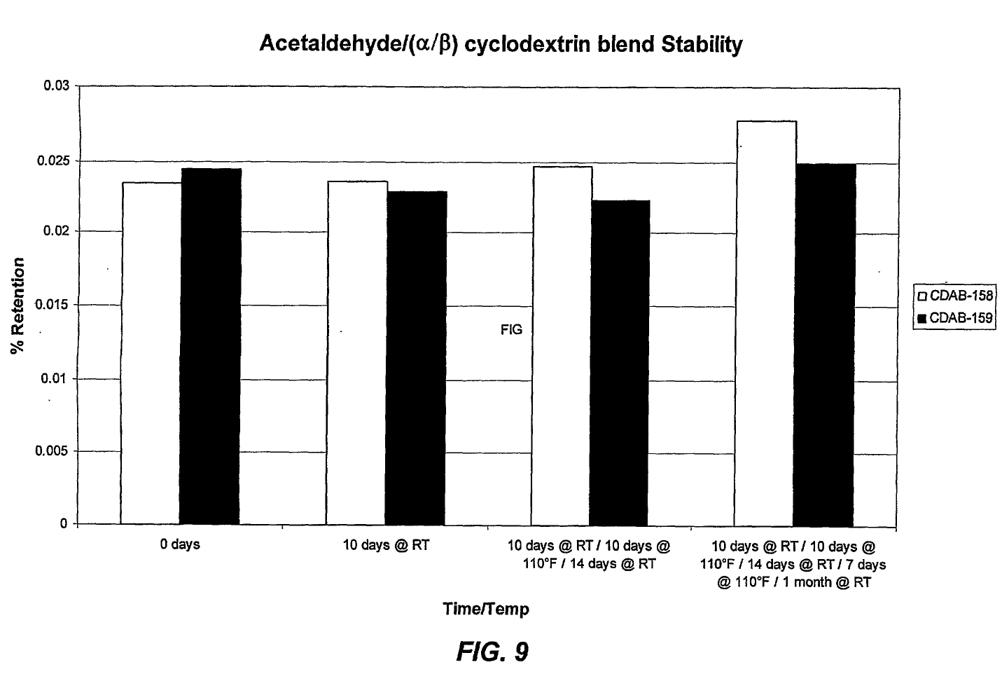

FIG. 9 and Tables 3-8 below illustrate the stability results of the acetaldehyde-α/β-cyclodextrin inclusion complexes described in Examples 26 and 27 (CDAB-158 and CDAB-159, respectively). The stability of each acetaldehyde-α/β-cyclodextrin inclusion complex was measured by determining the wt % retention of acetaldehyde at various timepoints and temperature conditions. At each timepoint, an acetaldehyde standard of known weight was run on the HPLC system four or five times, and the resulting area counts were averaged to achieve a reference data point that falls within the linear range of the calibration curve shown in FIG. 8. Each standard was prepared by adding 25 μLs of a 20% solution of acetaldehyde (in water) to a 10 mL volumetric flask containing mobile phase. The added weight in mgs is recorded and used to calculate the exact wt % standard.

As shown in Table 3 below, at time zero, approximately 100 mg (101.40 mg) of the resulting dry powder from Example 26, CDAB-158, was dissolved in 10 mL of 0.005 M sulfuric acid (using a 10 mL volumetric flask), and run on the HPLC system four times. A second sample of approximately 100 mg (105.10 mg) of CDAB-158 was then dissolved in 10 mL of 0.005 M sulfuric acid, and run on the HPLC system four times to achieve a total of 8 data points for CDAB-158. The HPLC injection volume for each run was 50 μL. Using the reference data point obtained from the standard (run five times and averaged), the area count corresponding to the acetaldehyde peak on the chromatogram for each of the eight HPLC runs was converted to mass (in mg) of acetaldehyde (e.g., 230*4.22/356=2.41, 206*4.22/356=2.44, etc.). The retention times for each HPLC run were also recorded to verify that the peaks analyzed corresponded to acetaldehyde. Then, based on the total mass of the test sample (i.e., 101.40 mg or 105.10 mg), the wt % of acetaldehyde to the total sample was calculated for each HPLC run and entered into the far right column of Table 3. Finally, the wt % retention of acetaldehyde for all eight HPLC runs were averaged to achieve a wt % retention of 2.35% acetaldehyde for CDAB-158. This “% retention” was recorded as the “0 day” data point for CDAB-158 in FIG. 9.

The wt % retention is the actually the wt % of acetaldehyde in the dry powder sample. The dry powder includes the acetaldehyde-α/β-cyclodextrin inclusion complex, but may also include free acetaldehyde, uncomplexed α-cyclodextrin, uncomplexed β-cyclodextrin, potassium citrate, xanthan gum, pectin, and water. However, because the other components of the dry powder are minimal compared to acetaldehyde and cyclodextrin, and because acetaldehyde is a relatively volatile guest, it is believed that the wt % of acetaldehyde in the dry power sample is substantially equal to, and therefore representative of, the wt % retention of acetaldehyde in α/β-cyclodextrin.

In addition, the percent moisture of the dry sample was evaluated after spray drying using a Denver Instruments (Arvada, Colo.) Loss on Drying Apparatus). The percent moisture of CDAB-158 was 6.57%.

As further shown in Table 3, some of the slurry from Example 26 comprising the acetaldehyde-α/β-cyclodextrin inclusion complex was not dried in the spray drier, and this slurry was also run four times in the HPLC system. A wt % retention was calculated for each of the four test samples of the slurry, using the same procedure as described above for the dry powder. The wt % retentions for the four samples were 2.71%, 2.70%, 2.69% and 2.72%. These wt % retentions of acetaldehyde are slightly higher than that of the dry powder, which could suggest that free (i.e., uncomplexed) acetaldehyde was present in the slurry but lost during the spray drying step.

TABLE 3
CDAB-158 wt % retention at time zero, evaluated using
HPLC with UV detection at 290 nm.
acetaldehyde by hplc UV @ 290 nm (time zero)

| sample | time | area count | mg/10 ml | wt (mg) | % |
|---|---|---|---|---|---|
| std per 10 ml #1 | 21.04 | 355 | | 4.22 | |
| std per 10 ml #2 | 21.04 | 358 | | 4.22 | |
| std per 10 ml #3 | 21.03 | 358 | | 4.22 | |
| std per 10 ml #4 | 21.03 | 354 | | 4.22 | |
| std per 10 ml #5 | 21.03 | 354 | | 4.22 | |
| average | | 356 | | 4.22 | |
| CDB-158 | 21.04 | 203 | 2.41 | 101.40 | 2.38 |
| | | 203 | 2.41 | 101.40 | 2.37 |
| | | 203 | 2.40 | 101.40 | 2.37 |
| | | 203 | 2.41 | 101.40 | 2.37 |
| CDB-158re | 21.02 | 206 | 2.44 | 105.10 | 2.32 |
| | | 207 | 2.46 | 105.10 | 2.34 |
| | | 208 | 2.47 | 105.10 | 2.35 |
| | | 204 | 2.42 | 105.10 | 2.31 |
| average retention = | | | | | 2.35 |
| slurry | 21.03 | 245 | 2.91 | 107.50 | 2.71 |
| | | 245 | 2.91 | 107.50 | 2.70 |
| | | 243 | 2.89 | 107.50 | 2.69 |
| | | 246 | 2.92 | 107.50 | 2.72 |

| | |
|---|---|
| percent moisture = | 6.57 |

As shown in Table 4 below, at time zero, approximately 100 mg (103.10 mg) of the resulting dry powder from Example 27, CDAB-159, was dissolved in 10 mL of 0.005 M sulfuric acid, and run on the HPLC system four times. A second sample of approximately 100 mg (115.30 mg) of CDAB-159 was then dissolved in 10 mL of 0.005 M sulfuric acid, and run on the HPLC system four times to achieve a total of 8 data points for CDAB-159. The HPLC injection volume for each run was 50 μL. Using the reference data point obtained from the standard (run four times and averaged), the area count corresponding to the acetaldehyde peak on the chromatogram for each of the eight HPLC runs was converted to mass (in mg) of acetaldehyde. The retention times for each HPLC run were also recorded to verify that the peaks analyzed corresponded to acetaldehyde. Then, based on the total mass of the test sample (i.e., 103.10 mg or 115.30 mg), the wt % of acetaldehyde to the total sample was calculated for each HPLC run and entered into the far right column of Table 3. Finally, the wt % retention of acetaldehyde for all eight HPLC runs were averaged to achieve a wt % retention of 2.45% acetaldehyde for CDAB-158. This “% retention” was recorded as the “0 day” data point for CDAB-159 in FIG. 9. The percent moisture of CDAB-158 was 6.36%. In addition, the slurry from Example 27 was run two times in the HPLC system prior to drying, and the wt % retentions for acetaldehyde were 3.51 wt % acetaldehyde. Again, this could suggest that free (i.e., uncomplexed) acetaldehyde was present in the slurry but lost during the spray drying step.

TABLE 4
CDAB-159 wt % retention at time zero, evaluated using
HPLC with UV detection at 290 nm.
acetaldehyde by hplc UV @ 290 nm (time zero)

| sample | time | area count | mg/10 ml | wt (mg) | % |
|---|---|---|---|---|---|
| std per 10 ml #1 | 20.99 | 423 | | 5.28 | |
| std per 10 ml #2 | 20.99 | 425 | | 5.28 | |
| std per 10 ml #3 | 20.99 | 424 | | 5.28 | |
| std per 10 ml #4 | 21.00 | 425 | | 5.28 | |
| average | | 424 | | 5.28 | |
| CDAB-159 #1 | 21.01 | 200 | 2.49 | 103.10 | 2.41 |
| | 21.02 | 200 | 2.49 | 103.10 | 2.41 |
| | 21.04 | 201 | 2.50 | 103.10 | 2.43 |
| | 21.04 | 207 | 2.57 | 103.10 | 2.50 |
| CDAB-159 #2 | 21.03 | 228 | 2.84 | 115.30 | 2.46 |
| | 21.03 | 226 | 2.81 | 115.30 | 2.44 |
| | 21.04 | 230 | 2.85 | 115.30 | 2.48 |
| | 21.03 | 230 | 2.86 | 115.30 | 2.48 |
| average retention = | | | | | 2.45 |
| slurry | 21.03 | 329 | 4.10 | 116.70 | 3.51 |
| | 20.99 | 329 | 4.10 | 116.70 | 3.51 |

| | |
|---|---|
| percent moisture = | 6.36 |

Table 5 shows similar data for CDAB-158 after sitting at room temperature (approximately 25 degrees C.) for 2 days. As shown in Table 5, the first sample of CDAB-158 had a mass of 101.40 mg and was run four times. The second sample had a mass of 105.80 mg and was run three times. The average wt % retention of acetaldehyde for these seven samples was about 2.36 wt %. Accordingly, the wt % retention of acetaldehyde after 2 days at room temperature did not vary much at all from time zero. As further shown in Table 5, a waste sample was run 3 times in the HPLC system and had a wt % retention of acetaldehyde of 1.40 wt %. The waste sample represents the last few percent of material remaining in a holding tank that cannot easily be pumped to the spray dryer. The acetaldehyde concentration is measured for safety monitoring and mass balance.

TABLE 5
CDAB-158 wt % retention after 2 d at room temperature,
evaluated using HPLC with UV detection at 290 nm.
acetaldehyde by hplc UV @ 290 nm (2 day stability)

| sample | time | area count | mg/10 ml | wt (mg) | % |
|---|---|---|---|---|---|
| std per 10 ml #1 | 21.04 | 355 | | 4.22 | |
| std per 10 ml #2 | 21.04 | 358 | | 4.22 | |
| std per 10 ml #3 | 21.03 | 358 | | 4.22 | |
| std per 10 ml #4 | 21.03 | 354 | | 4.22 | |
| std per 10 ml #5 | 21.03 | 354 | | 4.22 | |
| average | | 356 | | 4.22 | |
| CDB-158 | 21.04 | 203 | 2.41 | 101.40 | 2.38 |
| | | 203 | 2.41 | 101.40 | 2.37 |
| | | 203 | 2.40 | 101.40 | 2.37 |
| | | 203 | 2.41 | 101.40 | 2.37 |
| CDB-158re3* | 21.02 | 211 | 2.51 | 105.80 | 2.37 |
| | | 209 | 2.48 | 105.80 | 2.34 |
| | | 208 | 2.47 | 105.80 | 2.34 |
| waste sample | 21.03 | 124 | 1.47 | 105.10 | 1.40 |
| | | 124 | 1.47 | 105.10 | 1.40 |
| | | 124 | 1.47 | 105.10 | 1.40 |

*= 2 days @ RT

Table 6 shows the wt % retention for CDAB-158 and CDAB-159 after 10 days at room temperature. A standard was run three times and averaged to obtain a reference data point for the test samples. A sample of CDAB-158 having a mass of 100.50 mg was run three times in the HPLC system, and a sample of CDAB-159 having a mass of 104.90 mg was run three times in the HPLC system. The wt % retention of acetaldehyde was obtained for each sample run and averaged over the three runs to obtain a wt % retention of acetaldehyde of 2.29 wt % for CDAB-158 and 224 wt % for CDAB-159. These two data points were recorded in FIG. 9 as the “10 days @ RT” data points for CDAB-158 and CDAB-159. The moisture is not determined on the remaining (n/d) due to the limited amount of sample setup for testing.

TABLE 6
CDAB-158 and CDAB-159 wt % retention after 10 d
at room temperature, evaluated using HPLC with UV
detection at 290 nm.
acetaldehyde by hplc UV @ 290 nm 10 day RT

| sample | time | area count | mg/10 ml | wt (mg) | % |
|---|---|---|---|---|---|
| std per 10 ml #1 | 21.07 | 376 | | 4.26 | |
| std per 10 ml #2 | 21.06 | 376 | | 4.26 | |
| std per 10 ml #3 | 21.06 | 376 | | 4.26 | |
| average | | 376 | | 4.26 | |
| CDAB-158 10 day | 21.06 | 202 | 2.29 | 100.50 | 2.28 |
| | 21.04 | 204 | 2.31 | 100.50 | 2.30 |
| | 21.04 | 204 | 2.31 | 100.50 | 2.30 |
| average retention = | | | | | 2.29 |
| CDAB-159 10 day | 21.06 | 209 | 2.36 | 104.90 | 2.25 |
| | 21.04 | 208 | 2.35 | 104.90 | 2.24 |
| | 21.03 | 207 | 2.34 | 104.90 | 2.23 |
| average retention = | | | | | 2.24 |
| | 21.03 | 1 | 0.01 | 116.70 | 0.01 |
| | 20.99 | 1 | 0.01 | 116.70 | 0.01 |

| | |
|---|---|
| percent moisture = | n/d |

Table 7 shows the wt % retention for CDAB-158 and CDAB-159 after 10 days at room temperature (about 25 degrees C.), followed by 10 days at 110 degrees F. (about 43 degrees C.), followed by 14 days at room temperature. A standard was run four times and averaged to obtain a reference data point for the test samples. A sample of CDAB-158 having a mass of 100.00 mg was run twice in the HPLC system, and a sample of CDAB-159 having a mass of 100.10 mg was run twice in the HPLC system. The wt % retention of acetaldehyde was obtained for each sample run and averaged over the two runs to obtain a wt % retention of acetaldehyde of 2.47 wt % for CDAB-158 and 2.23 wt % for CDAB-159. These two data points were recorded in FIG. 9 as the “10 days @ RT/10 days @ 110° F./14 days @ RT” data points for CDAB-158 and CDAB-159.

TABLE 7
CDAB-158 and CDAB-159 wt % retention after 10 d
at room temperature, 10 days at 110 degrees F., and
14 days at room temperature, evaluated using HPLC
with UV detection at 290 nm.
10 days @ RT/10 days @ 110° F./14 days @ RT
acetaldehyde by hplc UV @ 290 nm

| sample | time | area count | mg/10 ml | wt (mg) | % |
|---|---|---|---|---|---|
| std per 10 ml #1 | 20.93 | 456 | | 6.34 | |
| std per 10 ml #2 | 20.93 | 455 | | 6.34 | |
| std per 10 ml #3 | 20.94 | 458 | | 6.34 | |
| std per 10 ml #4 | 20.94 | 452 | | 6.34 | |
| average | | 455 | | 6.34 | |
| CDAB-158 | 20.94 | 181 | 2.52 | 100.00 | 2.52% |
| | 20.94 | 174 | 2.43 | 100.00 | 2.43% |
| Average Retention | | | | | 2.47% |
| CDAB-159 | 20.95 | 159 | 2.22 | 100.10 | 2.22% |
| | 20.94 | 161 | 2.25 | 100.10 | 2.24% |

| | |
|---|---|
| Average Retention | 2.23% |

Table 8 shows the wt % retention for CDAB-158 and CDAB 176 (1.5× molar excess) over a 35 day period stored at 90 degrees F. The reduction in the acetaldehyde concentration in the original encapsulation and on storage does not have a major impact on the product or performance. The same HPLC procedure was used.

TABLE 8
CDAB-158 and CDAB-159 wt % retention after 10 d
at room temperature, 10 days at 110 degrees F., 14 days
at room temperature, 7 days at 110 degrees F., and
1 month at room temperature, evaluated using HPLC
with UV detection at 290 nm.

| | | | | | |
|---|---|---|---|---|---|
| sample | time | area count | mg/10 ml | wt (mg) | % |

acetaldehyde by hplc UV @ 290 nm (time zero)

| | | | | | |
|---|---|---|---|---|---|
| std per 10 ml #1 | 21.17 | 524 | | 6.16 | |
| std per 10 ml #2 | 21.17 | 524 | | 6.16 | |
| average | | 524 | | 6.16 | |
| CDAB-176 | 21.16 | 207 | 2.44 | 99.10 | 2.46 |
| | 21.16 | 207 | 2.43 | 99.10 | 2.45 |

| | |
|---|---|
| average percent = | 2.46 |

13 days @ 90° F.

| | | | | | |
|---|---|---|---|---|---|
| std per 10 ml #1 | 21.03 | 508 | | 6.56 | |
| std per 10 ml #2 | 21.03 | 507 | | 6.56 | |
| average | | 508 | | 6.56 | |
| CDAB-176 | 21.01 | 194 | 2.51 | 100.40 | 2.50 |
| | 20.99 | 195 | 2.52 | 100.40 | 2.51 |

| | |
|---|---|
| average retention = | 2.50 |

21 days @ 90° F.

| | | | | | |
|---|---|---|---|---|---|
| std per 10 ml #1 | 21.07 | 530 | | 6.12 | |
| std per 10 ml #2 | 21.07 | 532 | | 6.12 | |
| average | | 531 | | 6.12 | |
| CDAB-176 | 21.06 | 190 | 2.19 | 100.20 | 2.19 |
| | 21.05 | 190 | 2.20 | 100.20 | 2.19 |

| | |
|---|---|
| average retention = | 2.19 |

28 days @ 90° F.

| | | | | | |
|---|---|---|---|---|---|
| std per 10 ml #1 | 21.08 | 622 | | 7.68 | |
| std per 10 ml #2 | 21.07 | 621 | | 7.68 | |
| average | | 621 | | 7.68 | |
| CDAB-176 | 21.05 | 180 | 2.23 | 100.10 | 2.22 |
| | 21.04 | 179 | 2.21 | 100.10 | 2.21 |

| | |
|---|---|
| average retention = | 2.22 |

35 days @ 90° F.

| | | | | | |
|---|---|---|---|---|---|
| std per 10 ml #1 | 20.95 | 505 | | 6.04 | |
| std per 10 ml #2 | 20.96 | 508 | | 6.04 | |
| average | | 507 | | 6.04 | |
| CDAB-176 | 20.96 | 173 | 2.06 | 100.20 | 2.05 |
| | 20.94 | 175 | 2.08 | 100.20 | 2.08 |

| | |
|---|---|
| average retention = | 2.07 |

As shown in FIG. 9, the wt % retention of acetaldehyde in α/β-cyclodextrin was substantially stable over all times and temperatures tested. Although, a formal statistical analysis was not performed, the difference between the wt % retentions at the various time and temperature intervals for both CDAB-158 and CDAB-159 does not appear to be statistically significant. CDAB-175 and CDAB-176 behave in a similar fashion. A slight increase is observed in wt % retention of acetaldehyde over time and after being exposed to higher temperatures. Some slight increase in wt % retention suggests that some of the moisture (i.e., water) present in the dry powder samples may migrate at the higher temperatures and varies with the frequence of sampling from a single jar. Because cyclodextrin inclusion complexes of the present invention effectively retain the acetaldehyde. These results suggest the effectiveness of the cyclodextrin inclusion complexes in protecting and retaining the acetaldehyde, which is a relatively volatile guest (B.P.=21 degrees C. or 69.8 degrees F.) and normally considered difficult to retain and encapsulate.

### EXAMPLE 29

### Cyclodextrin Inclusion Complex with β-Cyclodextrin, Lemon Lime Oils, Pectin as an Emulsifier and Xanthan Gum as a Thickener, and Process for Forming Same

In a 1-L reactor, 400 g of β-cyclodextrin (W7 β-cyclodextrin, available from Wacker), 8 g of beet pectin (2 wt % of pectin: β-cyclodextrin; XPQ EMP 4 beet pectin available from Degussa-France), and 1.23 g xanthan gum (KELTROL xanthan gum, available from CP Kelco SAP No. 15695) were dry blended together to form a dry blend. 800 mL of deionized water were added to the dry blend to form a slurry or mixture. The 1-L reactor was set up for heating and cooling via a lab-scale water bath heating and cooling apparatus. The mixture was agitated by stirring for about 30 min. 21 g of lemon lime oils (flavor 043-03000, SAP No. 1106890 available from Degussa Flavors & Fruit Systems) was added. The reactor was sealed, and the resulting mixture was stirred for 4 hours at about 55-60 degrees C. The cooling portion of the heating and cooling lab apparatus was then turned on, and the mixture was stirred overnight at about 5-10 degrees C. The mixture was then spray dried on a BUCHI B-191 lab spray dryer (available from Buchi, Switzerland) having an inlet temperature of approximately 210 degrees C. and an outlet temperature of approximately 105 degrees C. A percent retention of about 4.99 wt % of lemon lime oils in the cyclodextrin inclusion complex was achieved.

### EXAMPLE 30

### Cyclodextrin Inclusion Complex with β-Cyclodextrin and Lemon Lime Oils, Pectin as an Emulsifier and Xanthan Gum as a Thickener, and Process for Forming Same

In a 1-L reactor, 300 g of β-cyclodextrin (W7 β-cyclodextrin, available from Wacker), 6 g of beet pectin (2 wt % of pectin: β-cyclodextrin; XPQ EMP 4 beet pectin available from Degussa-France), and 1.07 g xanthan gum (KELTROL xanthan gum, available from CP Kelco SAP No. 15695) were dry blended together to form a dry blend. 750 mL of deionized water were added to the dry blend to form a slurry or mixture. The 1-L reactor was set up for heating and cooling via a lab-scale water bath heating and cooling apparatus. The mixture was agitated by stirring for about 30 min. 16 g of lemon lime oils (flavor 043-03000, SAP No. 1106890 available from Degussa Flavors & Fruit Systems) was added. The reactor was sealed, and the resulting mixture was stirred for 4 hours at about 55-60 degrees C. The cooling portion of the heating and cooling lab apparatus was then turned on, and the mixture was stirred overnight at about 5-10 degrees C. The mixture was then emulsified using a high shear tank mixer (HP 5 1PQ mixer, available from Silverston Machines Ltd., Chesham England). A percent retention of about 5.06 wt % of lemon lime oils in the cyclodextrin inclusion complex was achieved.

### EXAMPLE 31

### Cyclodextrin Inclusion Complex with β-Cyclodextrin and Citral, Pectin as an Emulsifier and Xanthan Gum as a Thickener, and Process for Forming Same

In a 1-L reactor, 300 g of β-cyclodextrin (W7 β-cyclodextrin, available from Wacker), 6 g of beet pectin (2 wt % of pectin: β-cyclodextrin; XPQ EMP 4 beet pectin available from Degussa-France), and 0.90 g xanthan gum (KELTROL xanthan gum, available from CP Kelco SAP No. 15695) were dry blended together to form a dry blend, 575 mL of deionized water were added to the dry blend to form a slurry or mixture. The 1-L reactor was set up for heating and cooling via a lab-scale water bath heating and cooling apparatus. The mixture was agitated by stirring for about 30 min. 18 g of citral (natural citral, SAP No. 921565, Lot No. 10000223137, available from Citrus & Allied), were added. The reactor was sealed, and the resulting mixture was stirred for 4 hours at about 55-60 degrees C. The cooling portion of the heating and cooling lab apparatus was then turned on, and the mixture was stirred over the weekend at about 5-10 degrees C. The mixture was then divided into two halves. One half was emulsified neat using a high shear tank mixer (HP 5 1PQ mixer, available from Silverston Machines Ltd., Chesham England). 1 wt % gum acacia was added to the other half, and the resulting mixture was emulsified using the same high shear tank mixer. A percent retention of about 2.00 wt % of citral in the cyclodextrin inclusion complex was achieved.

### EXAMPLE 32

### Stable Beverage or Food Product Comprising a Cyclodextrin Inclusion Complex

Any of the resulting dry powders or emulsions formed according to Examples 19-27 and 28-31 is added directly to a food or beverage product to obtain a stable product with the appropriate flavor profile. The dry powders are then added directly to a food or beverage product as a dry powder, or the dry powders are suspended in a solvent to form an emulsion (with or without additional standard emulsification materials, e.g., maltodextrins, etc.) that are added directly to a food or beverage product, or sprayed onto a food substrate. The emulsions are added directly to a food or beverage product, or sprayed onto a food substrate.

TABLE 9
Sample log(P) values

| material | CAS# | log P¹ | mole wt |
|---|---|---|---|
| creatine | 57-00-1 | −3.72 | 131 |
| proline | 147-85-3 | −2.15 | 115 |
| diacetyl | 431-03-8 | −1.34 | 86 |
| methanol | 67-56-1 | −0.74 | 32 |
| ethanol | 64-17-5 | −0.30 | 46 |
| acetone | 67-64-1 | −0.24 | 58 |
| maltol | 118-71-8 | −0.19 | 126 |
| ethyl lactate | 97-64-3 | −0.18 | 118 |
| acetic acid | 64-19-7 | −0.17 | 60 |
| acetaldehyde | 75-07-0 | −0.17 | 44 |
| aspartame | 22839-47-0 | 0.07 | 294 |
| ethyl levulinate | 539-88-8 | 0.29 | 144 |
| ethyl maltol | 4940-11-8 | 0.30 | 140 |
| furaneol | 3658-77-3 | 0.82 | 128 |
| dimethyl sulfide | 75-18-3 | 0.92 | 62 |
| vanillin | 121-33-5 | 1.05 | 152 |
| benzyl alcohol | 100-51-6 | 1.05 | 108 |
| raspberry ketone | 5471-51-2 | 1.48 | 164 |
| benzaldehyde | 100-52-7 | 1.48 | 106 |
| ethyl vanillin | 121-32-4 | 1.50 | 166 |
| phenethyl alcohol | 60-12-8 | 1.57 | 122 |
| cis-3-hexenol | 928-96-1 | 1.61 | 100 |
| trans-2-hexenol | 928-95-0 | 1.61 | 100 |
| whiskey fusel oils | mixture | 1.75 | 74 |
| ethyl isobutyrate | 97-62-1 | 1.77 | 116 |
| ethyl butyrate | 105-54-4 | 1.85 | 116 |
| hexanol | 111-27-3 | 2.03 | 102 |
| ethyl-2-methyl butyrate | 7452-79-1 | 2.26 | 130 |
| ethyl isovalerate | 108-64-5 | 2.26 | 130 |
| isoamyl acetate | 123-92-2 | 2.26 | 130 |
| nutmeg oil | mixture | 2.90 | 164 |
| methyl isoeugenol | 93-16-3 | 2.95 | 164 |
| gamma undecalactone | 104-67-6 | 3.06 | 184 |
| alpha terpineol | 98-55-5 | 3.33 | 154 |
| chlorocyclohexane (CCH) | 542-18-7 | 3.36 | 118 |
| linalool | 78-70-6 | 3.38 | 154 |
| citral | 5392-40-5 | 3.45 | 152 |
| geraniol | 106-24-1 | 3.47 | 154 |
| citronellol | 106-22-9 | 3.56 | 154 |
| p-cymene | 99-87-6 | 4.10 | 134 |
| limonene | 138-86-3 | 4.83 | 136 |

All patents, publications and references cited herein are hereby fully incorporated by reference. In case of conflict between the present disclosure and incorporated patents, publications and references, the present disclosure should control. Various features and aspects of the invention are set forth in the following claims.

What is claimed is:

1. A method for preparing a cyclodextrin inclusion complex, the method comprising:
dry blending cyclodextrin, an emulsifier and a thickener to form a dry blend; and
mixing a solvent and a guest with the dry blend to form a mixture comprising a cyclodextrin inclusion complex.

2. The method of claim 1, further comprising drying the mixture to form a dry powder comprising the cyclodextrin inclusion complex.

3. A method for making an end product comprising adding the dry powder formed according to claim 2 to at least one of a beverage, a food product, a chewing gum, a dentifrice, a candy, a flavoring, a fragrance, a pharmaceutical, a nutraceutical, a cosmetic, an agricultural product, a photographic emulsion, a waste stream system, and a combination thereof.

4. The method of claim 2, wherein drying comprises at least one of air drying, vacuum drying, spray drying, oven drying, and a combination thereof.

5. The method of claim 1, further comprising emulsifying the mixture to form an emulsion comprising the cyclodextrin inclusion complex.

6. A method for making a beverage comprising adding the emulsion formed according to claim 5 to a beverage.

7. A method for making a food product comprising:
emulsifying the mixture of claim 1 to form an emulsion comprising the cyclodextrin inclusion complex; and
spraying the emulsion onto a substrate to form a food product.

8. The method of claim 1, wherein the emulsifier comprises a hydrocolloid.

9. The method of claim 1, wherein the emulsifier comprises at least one of xanthan gum, pectin, gum acacia, tragacanth, guar, carrageenan, locust bean, and a combination thereof.

10. The method of claim 1, wherein the emulsifier comprises pectin.

11. The method of claim 1, wherein the solvent comprises water.

12. The method of claim 1, wherein the cyclodextrin comprises at least one of α-cyclodextrin, β-cyclodextrin, γ-cyclodextrin, and a combination thereof.

13. The method of claim 1, wherein the guest comprises at least one of a flavor, an olfactant, a pharmaceutical, a nutraceutical, an antioxidant, and a combination thereof.

14. The method of claim 1, wherein the guest comprises at least one of diacetyl, citral, benzaldehyde, acetaldehyde, an essential oil, aspartame, creatine, alpha-tocopherol, and a combination thereof.

15. The method of claim 1, wherein the thickener comprises at least one of a gelling agent, a polysaccharide, a hydrocolloid, and a combination thereof.

16. The method of claim 1, wherein the thickener comprises xanthan gum.

17. The method of claim 1, wherein the weight percentage of emulsifier to cyclodextrin is at least about 0.5 wt %, and the weight percentage of thickener to cyclodextrin is at least about 0.07 wt %.

18. The method of claim 1, wherein the weight percentage of emulsifier to cyclodextrin is less than about 10 wt %, and the weight percentage of thickener to cyclodextrin is less than about 1.5 wt %.

19. The method of claim 1, wherein the guest has a positive log (P) value.

20. A method for preparing a cyclodextrin inclusion complex, the method comprising:
mixing cyclodextrin, an emulsifier and a thickener to form a first mixture;
mixing the first mixture with a solvent form a second mixture; and
mixing a guest with the second mixture to form a third mixture comprising a cyclodextrin inclusion complex.

21. The method of claim 20, wherein the emulsifier comprises pectin, the thickener comprises xanthan gum, and the solvent comprises water.

22. The method of claim 20, wherein the guest comprises at least one of diacetyl, citral, benzaldehyde, acetaldehyde, an essential oil, aspartame, creatine, alpha-tocopherol, and a combination thereof.

23. The method of claim 20, further comprising drying the third mixture to form a dry powder comprising the cyclodextrin inclusion complex.

24. A method for making an end product comprising adding the dry powder formed according to claim 23 to at least one of a beverage, a food product, a chewing gum, a dentifrice, a candy, a flavoring, a fragrance, a pharmaceutical, a nutraceutical, a cosmetic, an agricultural product, a photographic emulsion, a waste stream system, and a combination thereof.

25. The method of claim 20, further comprising emulsifying the third mixture to form an emulsion comprising the cyclodextrin inclusion complex.

26. A method of making a beverage comprising:
emulsifying the third mixture of claim 20 to form an emulsion comprising the cyclodextrin inclusion complex; and
adding the emulsion to a beverage.

27. A method of making a food product comprising:
emulsifying the mixture of claim 20 to form an emulsion comprising the cyclodextrin inclusion complex; and
spraying the emulsion onto a substrate to form a food product.

28. The method of claim 20, wherein the weight percentage of emulsifier to cyclodextrin is about 2 wt %, and the weight percentage of thickener to cyclodextrin is about 0.375 wt %.

29. The method of claim 20, wherein the guest has a log (P) value of at least about +1.

30. A method for preparing a cyclodextrin inclusion complex, the method comprising:
dry blending cyclodextrin, an emulsifier and a thickener to form a dry blend, the dry blend having a weight percentage of emulsifier to cyclodextrin of at least about 0.5 wt % and a weight percentage of thickener to cyclodextrin of at least about 0.07 wt %; and
mixing a solvent and a guest with the dry blend to form a mixture comprising a cyclodextrin inclusion complex.

31. The method of claim 30, wherein the emulsifier comprises pectin, the thickener comprises xanthan gum, and the solvent comprises water.

32. The method of claim 30, further comprising drying the mixture to form a dry powder comprising the cyclodextrin inclusion complex.

33. A method of forming an end product comprising adding the dry powder formed according to claim 32 to at least one of a beverage, a food product, a chewing gum, a dentifrice, a candy, a flavoring, a fragrance, a pharmaceutical, a nutraceutical, a cosmetic, an agricultural product, a photographic emulsion, a waste stream system, and a combination thereof.

34. The method of claim 30, further comprising emulsifying the mixture to form an emulsion comprising the cyclodextrin inclusion complex.

35. A method of forming an end product comprising adding the emulsion formed according to claim 34 to at least one of a beverage, a food product, a chewing gum, a dentifrice, a candy, a flavoring, a fragrance, a pharmaceutical, a nutraceutical, a cosmetic, an agricultural product, a photographic emulsion, a waste stream system, and a combination thereof.

36. The method of claim 30, wherein the guest comprises at least one of a flavor, an olfactant, a pharmaceutical, a nutraceutical, an antioxidant, and a combination thereof.

37. The method of claim 30, wherein the guest comprises at least one of diacetyl, citral, benzaldehyde, acetaldehyde, an essential oil, aspartame, creatine, alpha-tocopherol, and a combination thereof.

38. The method of claim 30, wherein dry blend comprises a weight percentage of emulsifier to cyclodextrin of about 2 wt % and a weight percentage of thickener to cyclodextrin of about 0.375 wt %.
